(19) United States
(12) Patent Application Publication
(10) Pub. No.: US 2026/0156528 A1
(43) Pub. Date: Jun. 4, 2026

(54) INFORMATION TRANSMITTING METHOD AND APPARATUS

(71) Applicant: 1FINITY Inc., Kawasaki-shi (JP)

(72) Inventors: Guorong LI, Beijing (CN); Su YI, Beijing (CN); Meiyi JIA, Beijing (CN); Xin WANG, Beijing (CN)

(73) Assignee: 1FINITY Inc., Kawasaki-shi (JP)

(21) Appl. No.: 19/464,785

(22) Filed: Jan. 30, 2026

Related U.S. Application Data
(63) Continuation of application No. PCT/CN2023/110997, filed on Aug. 3, 2023.

(51) Int. Cl. H04W 28/06; H04W 24/10; H04W 76/12

(52) U.S. Cl. CPC H04W 28/06; H04W 24/10; H04W 76/12

(57) ABSTRACT

An information transmitting apparatus, configured in a terminal equipment, includes: processor circuitry configured to trigger a delay information reporting at a media access control layer of the terminal equipment; and a transmitter configured to transmit the delay information reporting to a network device via a media access control control element, wherein that the processor circuitry triggers the delay information report at the media access control layer of the terminal equipment comprises: the media access control layer of the terminal equipment determines whether to trigger the delay information report according to a value of at least one discard timer.

### CROSS-REFERENCE TO RELATED APPLICATION

This application is a continuation application under 35 U.S.C. 111 (a) of International Patent Application PCT/CN2023/110997 filed on Aug. 3, 2023, and designated the U.S., the entire contents of which are incorporated herein by reference.

### FIELD

Embodiments of the present disclosure relate to the technical field of communications.

### BACKGROUND

3GPP (3rd Generation Partnership Project) begins to study enhancements for Extended Reality (XR) service in Release 18 (version), and the XR service refers to environment and human-computer interaction of all real and virtual combinations produced by computer technologies and wearable devices. The XR service may include virtual reality (VR) service, augmented reality (AR) service and mixed reality (MR) service.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

Inventor finds that the XR service has strict latency limits. To meet QoS (Quality of Service) requirements for the XR service, a scheduler with latency information is needed. The scheduler with latency information is achievable in the downlink because a network device knows a user's QoS characteristics (for example, indicated via a 5QI (5G QoS Identifier)) and also knows an arrival time of XR frames (packets), thus knows an urgency degree of scheduling buffered data. However, for uplink, a current BSR (Buffer Status Report) only provides a size of a buffered data volume, but does not convey information on how long the data has been buffered in a UE (User Equipment), therefore, a scheduler at a network device side cannot precisely know a buffer time of the data in the UE, there may be a situation where the XR service exceeds its latency requirements and is not configured with uplink resources, resulting in failure to meet QoS requirements for the XR service or data loss, which leads to a decline in user experience.

For at least one of the above problems or other similar problems, the embodiments of the present disclosure provide an information transmitting method and apparatus, to meet latency requirements for the XR service, thereby ensuring QoS of the XR service.

According to an aspect of the embodiments of the present disclosure, an information transmitting apparatus is provided, configured in a terminal equipment, the apparatus comprises:
a triggering unit configured to trigger delay information reporting at a packet data convergence protocol layer or a media access control layer of the terminal equipment; and
a transmitting unit configured to transmit the delay information reporting to a network device via a media access control control element or a packet data convergence protocol control protocol data unit.

According to another aspect of the embodiments of the present disclosure, a communication apparatus is provided, configured in a terminal equipment, wherein the apparatus comprises:
an indicating unit configured to indicate to a network device that the terminal equipment supports calculating or triggering or reporting delay information or remaining time, and/or
a receiving unit configured to receive configuration information from the network device, the configuration information being used to configure to calculate or trigger or report the delay information or the remaining time for at least one radio bearer of the terminal equipment.

According to another aspect of the embodiments of the present disclosure, an information transmitting apparatus is provided, configured in a terminal equipment, wherein the apparatus comprises:
a transmitting unit configured to transmit delay information reporting to a network device; and
a processing unit configured to perform processing related to de-prioritization of the delay information reporting.

According to another aspect of the embodiments of the present disclosure, a communication apparatus is provided, configured in a network device, wherein the apparatus comprises:
a receiving unit configured to receive indication information from a terminal equipment, the indication information being used to indicate the network device that the terminal equipment supports calculating or triggering or reporting delay information, and/or,
a configuring unit configured to calculate or trigger or report the delay information for at least one radio bearer of the terminal equipment.

According to a further aspect of the embodiments of the present disclosure, a communication system is provided, comprising a terminal equipment and a network device, wherein the terminal equipment is configured to execute the following method:
triggering delay information reporting at a packet data convergence protocol layer or a media access control layer; and
transmitting the delay information reporting to a network device via a media access control control element or a packet data convergence protocol control protocol data unit.

One of advantageous effects of the embodiments of the present disclosure lies in: according to the embodiments of the present disclosure, delay information reporting is triggered at a PDCP layer or MAC layer of a terminal equipment, and the delay information reporting is transmitted via a MAC CE or a PDCP control PDU, which helps the terminal equipment to timely transmit the delay information reporting to the network device, in addition, the network device may timely allocate appropriate uplink resources for transmission of an XR service according to contents of the delay information reporting, which helps meet latency requirements for the XR services, thereby ensuring QoS of the XR service, and may further improve a utilization rate of a radio resource.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF THE DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of configuring a PDCP discard timer for a UE;

FIG. 2 is a schematic diagram of an information transmitting method in the embodiments of the present disclosure;

FIG. 3 is a schematic diagram in which a terminal equipment triggers and transmits delay information reporting in the embodiments of the present disclosure;

FIG. 4 is another schematic diagram in which a terminal equipment triggers and transmits delay information reporting in the embodiments of the present disclosure;

FIG. 5 is another schematic diagram in which a terminal equipment triggers and transmits delay information reporting in the embodiments of the present disclosure;

FIG. 6 is another schematic diagram in which a terminal equipment triggers and transmits delay information reporting in the embodiments of the present disclosure;

FIG. 7 is another schematic diagram of an information transmitting method in the embodiments of the present disclosure;

FIG. 8 is a schematic diagram of a communication method in the embodiments of the present disclosure;

FIG. 9 is a schematic diagram of priority processing within a UE;

FIG. 10 is a schematic diagram of an information transmitting method in the embodiments of the present disclosure;

FIG. 11 is a schematic diagram of a communication method in the embodiments of the present disclosure.

FIG. 12 is a schematic diagram of an example of an information transmitting apparatus in the embodiments of the present disclosure;

FIG. 13 is a schematic diagram of an example of a communication apparatus in the embodiments of the present disclosure;

FIG. 14 is a schematic diagram of an example of an information transmitting apparatus in the embodiments of the present disclosure;

FIG. 15 is a schematic diagram of an example of a communication apparatus in the embodiments of the present disclosure;

FIG. 16 is a schematic diagram of a terminal equipment in the embodiments of the present disclosure;

FIG. 17 is a schematic diagram of a network device in the embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.), an Integrated Access and Backhaul (IAB) node or an IAB-DU or an IAB-donor. And the term “base station” may include their some or all functions, each base station may provide communication coverage to a specific geographic region. The term “cell” may refer to a base station and/or its coverage area, which depends on the context in which this term is used. In a case where there is no confusion, the terms “cell” and “base station” are interchangeable.

In the embodiments of the present disclosure, the term “User Equipment (UE)” or “Terminal Equipment (TE) or Terminal Device” refers to, for example, a device that accesses a communication network and receives network services through a network device. The terminal equipment can be fixed or mobile, and can also be referred to as Mobile Station (MS), a terminal, Subscriber Station (SS), Access Terminal (AT), IAB-MT (Mobile Terminal), a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera, a wearable device and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above, or may further be a device in a core network. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

In the MAC (Media Access Control) specification, regarding triggering of a BSR, there is the following description:

A BSR shall be triggered if any of the following events occur:
UL data, for a logical channel which belongs to an LCG, becomes available to the MAC entity; and either
this UL data belongs to a logical channel with higher priority than the priority of any logical channel
containing available UL data which belong to any LCG; or
none of the logical channels which belong to an LCG contains any available UL data.
in which case the BSR is referred below to as ‘Regular BSR’;
UL resources are allocated and number of padding bits is equal to or larger than the size of the Buffer
Status Report MAC CE plus its subheader, in which case the BSR is referred below to as ‘Padding BSR’;
retxBSR-Timer expires, and at least one of the logical channels which belong to an LCG contains UL data,
in which case the BSR is referred below to as ‘Regular BSR’;
periodicBSR-Timer expires, in which case the BSR is referred below to as ‘Periodic BSR’.
NOTE 1:
When Regular BSR triggering events occur for multiple logical channels simultaneously, each logical channel triggers one separate Regular BSR.

In addition, in the MAC specification, regarding the content of the BSR, there is the following description:

The fields in the BSR MAC CE are defined as follows:
LCG ID: The Logical Channel Group ID field identifies the group of logical channel(s) whose buffer
status is being reported. The length of the field is 3 bits;
LCGᵢ: For the Long BSR format and Pre-emptive BSR format, this field indicates the presence of the
Buffer Size field for the logical channel group i. The LCGᵢ field set to 1 indicates that the Buffer Size
field for the logical channel group I is reported. The LCGᵢ field set to 0 indicates that the Buffer Size field
for the logical channel group i is not reported. For the Long Truncated BSR format, this field indicates
whether logical channel group i has data available. The LCGᵢ field set to 1 indicates that logical channel
group i has data available. The LCGᵢ field set to 0 indicates that logical channel group i does not have
data available;
Buffer Size: The Buffer Size field identifies the total amount of data available according to the data
volume calculation procedure in TSs 38.322 [3] and 38.323 [4] across all logical channels of a logical
channel group after the MAC PDU has been built (i.e. after the logical channel prioritization procedure,
which may result the value of the Buffer Size field to zero). The amount of data is indicated in number of
bytes. The size of the RLC headers and MAC subheaders are not considered in the buffer size
computation. The length of this field for the Short BSR format and the Short Truncated BSR format is 5
bits. The length of this field for the Long BSR format and the Long Truncated BSR format is 8 bits. The
values for the 5-bit and 8-bit Buffer Size fields are shown in Tables 6.1.3.1-1 and 6.1.3.1-2, respectively.
For the Long BSR format and the Long Truncated BSR format, the Buffer Size fields are included in
ascending order based on the LCGᵢ. For the Long Truncated BSR format the number of Buffer Size
fields included is maximised, while not exceeding the number of padding bits. For the Pre-emptive BSR
format, the Buffer Size field identifies the total amount of the data expected to arrive at the IAB-MT of
the node where the Pre-emptive BSR is triggered and does not include the volume of data currently
available in the IAB-MT. Pre-emptive BSR format is identical to the Long BSR format.

Moreover, for the XR service, a UE calculates remaining time based on a value of a discard timer (discardTimer) of a PDCP (Packet Data Convergence Protocol), and each PDCP SDU (Service Data Unit) is associated with a discardTimer. If a transmitting PDCP entity of the UE receives a PDCP SDU from an upper layer, the transmitting PDCP entity of the UE starts the discardTimer associated with the SDU.

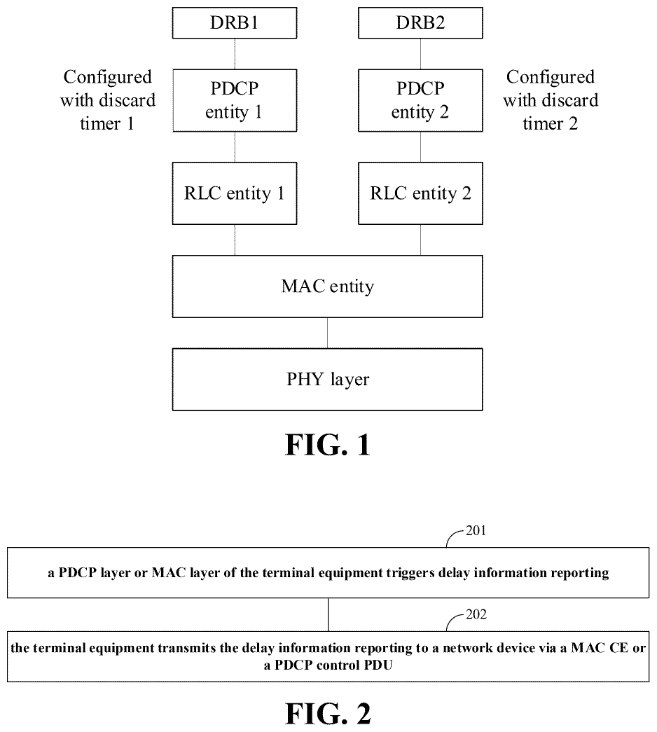

FIG. 1 is a schematic diagram of configuring a PDCP discard timer for a UE. In the embodiments of the present disclosure, at least one XR service may be established in the UE, therefore at least one Data Radio Bearer (DRB) may be established, at least one DRB corresponds to at least one PDCP entity and at least one RLC entity. FIG. 1 makes illustration by establishing two DRBs as an example. An initial value of the discardTimer is configured in a relevant configuration of the DRB when a network device configures the DRB for the UE. In addition, the initial value of the discardTimer may be correspondingly configured by the network device according to latency requirements of the PDCP SDU, the embodiments of the present disclosure do not impose limitations thereto.

As shown in FIG. 1, when receiving a PDCP SDU from the upper layer (such as an SDAP layer, Service Data Adaptation Protocol), if the discardTimer is configured, the PDCP entity of the UE starts the discardTimer associated with the PDCP SDU. When the discardTimer associated with a PDCP SDU expires, the PDCP entity of the UE discards the PDCP SDU and corresponding PDCP data PDUs (Protocol Data Unit).

In the embodiments of the present disclosure, the terminal equipment transmits Delay Information Reporting (DIR) to the network device, the delay information reporting may be transmitted in a MAC control element (MAC CE), for example, is transmitted by using a BSR MAC CE, or is transmitted by using other MAC CE. The delay information reporting may further be transmitted in a PDCP control PDU. The embodiments of the present disclosure do not impose limitations thereto.

Embodiments of the present disclosure are described below in conjunction with the drawings and the specific implementations.

In the following description, without causing confusion, “if . . . ” may be replaced with “in a case where . . . ” or “when . . . ”; “a value of a discard timer” and “a value of a first remaining time” are interchangeable.

### Embodiments of a First Aspect

Embodiments of the present disclosure provide an information transmitting method, which is described from a terminal equipment side.

FIG. 2 is a schematic diagram of an information transmitting method in the embodiments of the present disclosure. As shown in FIG. 2, the method includes:
201: a PDCP layer or MAC layer of the terminal equipment triggers delay information reporting; and
202: the terminal equipment transmits the delay information reporting to a network device via a MAC CE or a PDCP control PDU.

It should be noted that the above FIG. 2 only schematically describes the embodiments of the present disclosure, but the present disclosure is not limited to this. For example, some other operations can be increased or operations therein may be reduced. Persons skilled in the art may make appropriate modifications according to the above contents, not limited to the records in the above FIG. 2.

According to the above embodiments, a PDCP layer or MAC layer of a terminal equipment triggers delay information reporting, and transmits the delay information reporting via a MAC CE or a PDCP control PDU, which helps the terminal equipment to timely transmit the delay information reporting to the network device, in addition, the network device may timely allocate appropriate uplink resources for transmission of an XR service according to contents of the delay information reporting, which helps meet latency requirements of the XR services, thereby ensuring QoS of the XR service, and may further improve a utilization rate of a radio resource.

The following will respectively describe situations where a UE triggers delay information reporting at the PDCP layer and situations where the UE triggers the delay information reporting at the MAC layer.

In 201, in some embodiments, that the PDCP layer of the terminal equipment triggers the delay information reporting comprises at least one of the following:
if a value of a discard timer or a value of a first remaining time associated with a PDCP SDU in a PDCP entity is lower than a first threshold, the PDCP entity triggers the delay information reporting;
if a minimum value of a discard timer or of a first remaining time associated with all PDCP SDUs in a PDCP entity is lower than a second threshold, the PDCP entity triggers the delay information reporting;
if a minimum value of a discard timer or of a first remaining time associated with all PDCP SDUs in a PDCP entity associated with a DRB established by the terminal equipment or configured for the terminal equipment is lower than a third threshold, the PDCP layer of the terminal equipment triggers the delay information reporting;
a PDCP layer of the terminal equipment periodically triggers the delay information reporting; or a PDCP layer of the terminal equipment triggers the delay information reporting when a new PDU set reaches the PDCP layer.

In the above embodiments, a PDCP entity processes at least one PDCP SDU, each PDCP SDU is associated with a discard timer, an initial value of the discard timer is configured by the network device. After the discard timer is started, the value of the discard timer decreases over time.

In the above embodiments, the value of the first remaining time may be the value of the discarded timer. To distinguish from “the initial value of the discarded timer”, “the value of the discarded timer” is also called “a current value of the discarded timer” or “a remaining value of the discarded timer” in cases. In addition, the value of the first remaining time may further be determined by the UE based on the value of the discard timer, for example: the value of the first remaining time is determined by a PDCP entity corresponding to one DRB of the UE, that is, one PDCP entity determines a value of one first remaining time, and different PDCP entities may determine values of different first remaining times. For example, one PDCP entity may determine a minimum value or a value lower than a predetermined threshold in values of the discard timer associated with PDCP SDUs as a value of the first remaining time.

For another example, the value of the first remaining time is determined by PDCP entities corresponding to all established or configured DRBs of the UE, i.e., a PDCP layer of the UE determines a value of one first remaining time. For example, in PDCP entities corresponding to all established or configured DRBs, a minimum value or a value lower than a predetermined threshold in values of the discard timer associated with the PDCP SDUs is determined as the value of the first remaining time.

For another example, the value of the first remaining time is determined by the UE according to a PDU set. For example, a minimum value or a value lower than a predetermined threshold in values of the discard timer associated with PDCP SDUs corresponding to PDUs in one PDU set is determined as the value of the first remaining time.

In the above embodiments, the value of the predetermined threshold may be predefined or is configured by a network, the embodiments of the present disclosure do not impose limitations thereto.

In a case where the value of the discard timer or the value of the first remaining time associated with one PDCP SDU in one PDCP entity is lower than a first threshold, the PDCP entity may trigger at least one delay information reporting, for example, in the PDCP entity, there are multiple PDCP SDUs in which the value of the associated discard timer or the value of the first remaining time is lower than the first threshold, and the PDCP entity may trigger multiple delay information reportings corresponding to the multiple PDCP SDUs respectively.

In a case where the minimum value of the discard timer or of the first remaining time associated with all PDCP SDUs in one PDCP entity is lower than a second threshold, the PDCP entity triggers one delay information reporting corresponding to the PDCP entity; moreover, in a case where the minimum value of the discard timer or of the first remaining time associated with all PDCP SDUs in each of multiple PDCP entities is lower than a second threshold, each of the multiple PDCP entities may trigger corresponding delay information reporting.

In a case where the minimum value of the discard timer or of the first remaining time associated with all PDCP SDUs in a PDCP entity associated with a DRB established by the UE or configured for the UE is lower than a third threshold, the PDCP layer of the UE triggers one delay information reporting.

The above threshold values (values of the first threshold to the third threshold) may be pre-set or be configured by the network device (for example, configured via an RRC reconfiguration message), the present disclosure does not impose limitations on their values and configuring methods.

In the above embodiments, the delay information reporting may further be triggered periodically by the PDCP layer of the UE, and a triggering period may be predefined or is configured by the network device (for example, configured via an RRC reconfiguration message).

In the above examples, one PDU set consists of one or more PDUs (Protocol Data Units) carrying a payload of one unit information generated by an application layer, such as one frame of service or video slice. The PDU set (PDU group) is latency-sensitive. If a new PDU set reaches the PDCP layer, the UE triggers the delay information reporting and transmits it to the network device, the network device is able to promptly allocate appropriate uplink resources for transmission of the XR service according to the content of the delay information reporting, which is conducive to meeting latency requirements of the XR service, thereby ensuring the QoS of the XR service, and a utilization rate of a radio resource may also be improved.

A method for transmitting delay information reporting in a case where the delay information reporting is triggered at a PDCP layer will be described below.

In some embodiments, that the terminal equipment transmits the delay information reporting via a MAC CE comprises:
a PDCP layer transfers a value of a discard timer or a value of a first remaining time to a MAC layer;
the MAC layer determines a value of a second remaining time according to the value of the discard timer or the value of the first remaining time; and
the MAC layer generates a delay information reporting MAC CE and transmits the delay information reporting MAC CE to the network device, the delay information reporting MAC CE containing the value of the second remaining time.

In the above embodiments, the PDCP layer may transfer one or more values of the discard timer or one or more values of the first remaining time to the MAC layer, wherein the value of the discard timer may correspond to a value of the discard timer at a time when the delay information reporting is triggered, or a value of the discard timer at a time when triggering of the delay information reporting is transferred from the PDCP layer to the MAC layer.

In the above embodiments, the value of the second remaining time is a value of remaining time corresponding to a time when the delay information reporting is transmitted for the first time.

In the above embodiments, that the MAC layer determines a value of a second remaining time according to the value of the discard timer or the value of the first remaining time comprises:
the MAC layer starts a first timer upon receiving the value of the discard timer or the value of the first remaining time transferred by the PDCP layer, the value of the first timer being set to be the value of the discard timer or the value of the first remaining time transferred by the PDCP layer; and
the MAC layer determines the value of the second remaining time according to the value of the first timer, the value of the second remaining time being a value of the first timer corresponding to a time when the delay information report is transmitted for the first time.

Thereby, the remaining time corresponding to a time when the delay information reporting is transmitted for the first time is obtained via the first timer.

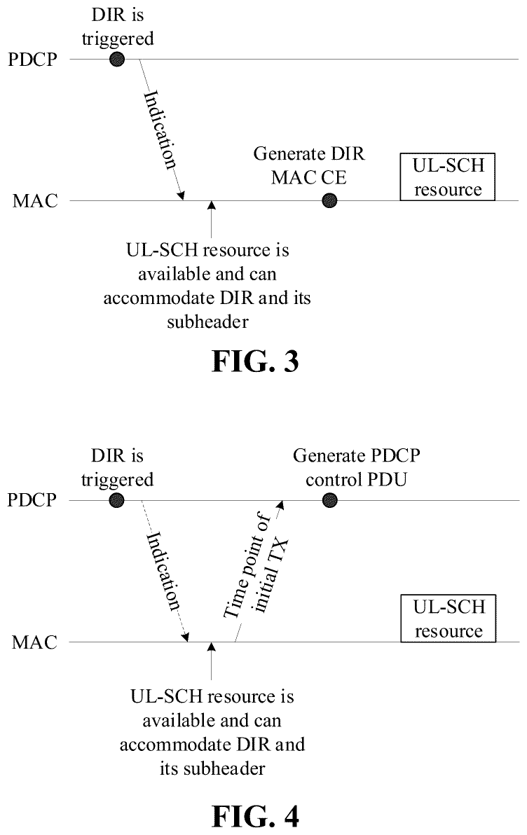

FIG. 3 is a schematic diagram in which a terminal equipment triggers and transmits delay information reporting in the embodiments of the present disclosure. FIG. 3 shows an interaction process between a PDCP layer and a MAC layer in a case where the PDCP layer triggers the delay information reporting and transmits the delay information reporting at the MAC layer via a MAC CE.

In the above embodiments, as shown in FIG. 3, after triggering the delay information reporting, the PDCP layer may indicate the MAC layer that the delay information reporting is triggered; in addition, after triggering the delay information reporting, the PDCP layer may indicate the MAC layer to generate a delay information reporting MAC CE, and upon receiving the indication, the MAC layer generates the delay information reporting MAC CE. Moreover, in the above examples, the value of the second remaining time e.g. is a value of remaining time corresponding to a time when the delay information reporting MAC CE is transmitted for the first time.

In the above embodiments, as shown in FIG. 3, the MAC layer may further determine uplink resources before generating the delay information reporting MAC CE. For example, the MAC layer generates the delay information reporting MAC CE in the case of determining that an Uplink Shared Channel (UL-SCH) resource is available and is capable of accommodating the delay information reporting and a subheader of the delay information reporting.

In some embodiments, the terminal equipment transmits the delay information reporting via a PDCP control PDU, in which, remaining time in the delay information reporting may be determined at the PDCP layer or at the MAC layer.

In some embodiments, the UE may determine remaining time in the delay information reporting at the PDCP layer, for example,
the MAC layer notifies the PDCP layer of a time when a UL-SCH resource that may be used for initial or new transmission of the delay information reporting is located;
the PDCP layer determines the value of the second remaining time according to a time when the UL-SCH resource is located;
the PDCP layer generates a PDCP control PDU and transmits the delay information reporting to the network device via the PDCP control PDU, the delay information reporting containing the value of the second remaining time.

In some embodiments, the UE may determine remaining time in the delay information reporting at the MAC layer, for example,
the MAC layer determines the value of the second remaining time contained in the delay information reporting;
the MAC layer notifies the PDCP layer of the value of the second remaining time;
the PDCP layer generates a PDCP control PDU and transmits the delay information reporting to the network device via the PDCP control PDU, the delay information reporting containing the value of the second remaining time.

In the above embodiments, the MAC layer may determine the value of the second remaining time via a timer, for example,
the PDCP layer transfers the value of the discard timer or the value of the first remaining time to the MAC layer;
the MAC layer starts a second timer upon receiving the value of the discard timer or the value of the first remaining time transferred by the PDCP layer, the value of the second timer being set to be the value of the discard timer or the value of the first remaining time transferred by the PDCP layer; and
the MAC layer determines the value of the second remaining time according to the value of the second timer, the value of the second remaining time being a value of the second timer corresponding to a time when the delay information reporting is transmitted for the first time.

FIG. 4 is another schematic diagram in which a terminal equipment triggers and transmits delay information reporting in the embodiments of the present disclosure. FIG. 4 shows an interaction process between a PDCP layer and a MAC layer in a case where the PDCP layer triggers the delay information reporting and transmits the delay information reporting via a PDCP control PDU.

In the above embodiments, as shown in FIG. 4, the MAC layer may further determine uplink resources before notifying the PDCP layer of a time when the UL-SCH resource that may be used for initial transmission or new transmission of the delay information reporting is located, for example, the MAC layer notifies the PDCP layer of a time when the UL-SCH resource that may be used for initial transmission or new transmission is located in the case of determining that the UL-SCH resource is available and is capable of accommodating the delay information reporting and a subheader of the delay information reporting.

In the above embodiments, as shown in FIG. 4, after triggering the delay information reporting, the PDCP layer may indicate the MAC layer that the delay information reporting is triggered.

In the above embodiments, situations where a UE triggers delay information reporting at the PDCP layer are described, and situations where the UE triggers the delay information reporting at the MAC layer will be described below.

In 201, in some embodiments, that the MAC layer of the terminal equipment triggers the delay information reporting comprises:
a PDCP layer of the terminal equipment transfers a value of at least one discard timer or a value of at least one first remaining time associated with the PDCP SDU in a PDCP entity to the MAC layer; and
the MAC layer of the terminal equipment determines whether to trigger the delay information reporting according to the value of the at least one discard timer or the value of the at least one first remaining time.

In the above embodiments, the PDCP layer may directly transfer the value of at least one discard timer or the value of at least one first remaining time associated with the PDCP SDU in the PDCP entity to the MAC layer, and when the value of the at least one discard timer or the value of the at least one first remaining time is less than an eleventh threshold, the MAC layer triggers the delay information reporting.

In the above embodiments, the PDCP layer may further first compare the value of at least one discard timer or the value of at least one first remaining time associated with the PDCP SDU in the PDCP entity, and transfer a smaller or minimum value in these values to the MAC layer, such that the MAC layer determines whether to trigger the delay information reporting according to the smaller or minimum value.

For example, the PDCP entity obtains a minimum value of the discard timers or of the first remaining times associated with all PDCP SDUs in the PDCP entity, and transfers the minimum value to the MAC layer; when a minimum value in the minimum values transferred by all PDCP entities is less than a fourth threshold, the MAC layer triggers the delay information reporting.

For another example, the PDCP layer transfers a minimum value in the values of the discard timers or in the values of the first remaining times associated with all PDCP SDUs to the MAC layer; the MAC layer triggers the delay information reporting when the minimum value is less than a fifth threshold.

For another example, the PDCP entity or PDCP layer transfers value of more than one discard timer or value of more than one first remaining time to the MAC layer, for example, one PDCP entity or PDCP layer may transfer values of discard timers or values of the first remaining times associated with all PDCP SDUs, or may transfer values of at least N discard timers or values of at least N first remaining times, N being an integer greater than 1; the MAC layer triggers the delay information reporting when a minimum value in the value of the more than one discard timer or value of the more than one first remaining time is less than the sixth threshold.

The above threshold values (values of the fourth threshold to the sixth threshold and the eleventh threshold) may be pre-set or be configured by the network device, the present disclosure does not impose limitations on their values and configuring methods.

In 201, in some embodiments, that the MAC layer of the terminal equipment triggers the delay information reporting comprises:
the MAC layer of the terminal equipment obtains a value of at least one discard timer or a value of at least one first remaining time; and
the MAC layer of the terminal equipment determines whether to trigger the delay information reporting according to the value of the at least one discard timer or the value of the at least one first remaining time.

In the above embodiments, the value of the at least one discard timer or the value of the at least one first remaining time is not required to be transferred to the MAC layer via the PDCP layer, it may be obtained by the MAC layer according to a predetermined policy, for example may be obtained by the MAC layer according to internal implementation of the UE.

In the above embodiments, the MAC layer may directly compare the obtained value of the at least one discard timer or the obtained value of the at least one first remaining time with a threshold value to determine whether to trigger the delay information reporting, for example the MAC layer triggers the delay information reporting when the value of the at least one discard timer or the value of the at least one first remaining time is less than a seventh threshold; the MAC layer may further first compare the obtained value of the at least one discard timer or the obtained value of the at least one first remaining time to obtain a minimum value, and then compare the minimum value with a threshold value to determine whether to trigger the delay information reporting, for example the MAC layer triggers the delay information reporting when a minimum value in the value of the at least one discard timer or the value of the at least one first remaining time is less than the seventh threshold.

In the above embodiments, the MAC layer may further determine whether to trigger the delay information reporting by starting a timer, for example the MAC layer starts a third timer when receiving the value of the discarded timer or the value of the first remaining time transferred by the PDCP layer, the value of the third timer being set to be the value of the discard timer or the value of the first remaining time transferred by the PDCP layer; and triggers the delay information reporting when the value of the third timer is lower than an eighth threshold.

Values of the seventh threshold and of the eighth threshold may be pre-set or be configured by the network device, the present disclosure does not impose limitations on their values and configuring methods.

A method for transmitting delay information reporting in a case where the delay information reporting is triggered at the MAC layer will be described below.

In some embodiments, that the terminal equipment transmits the delay information reporting via a MAC CE comprises:
a MAC layer determines a value of a second remaining time according to a value of at least one discard timer or a value of at least one first remaining time; and
the MAC layer generates a delay information reporting MAC CE and transmits the delay information reporting MAC CE to the network device, the delay information reporting MAC CE containing the value of the second remaining time.

In the above embodiments, the value of the second remaining time is a value of remaining time corresponding to a time when the delay information reporting is transmitted for the first time; or,
the value of the second remaining time is a value of a third timer corresponding to a time when the delay information reporting is transmitted for the first time, the third timer being a timer started by the MAC layer of the terminal equipment when receiving the value of the at least one discard timer or the value of the at least one first remaining time transferred by the PDCP layer.

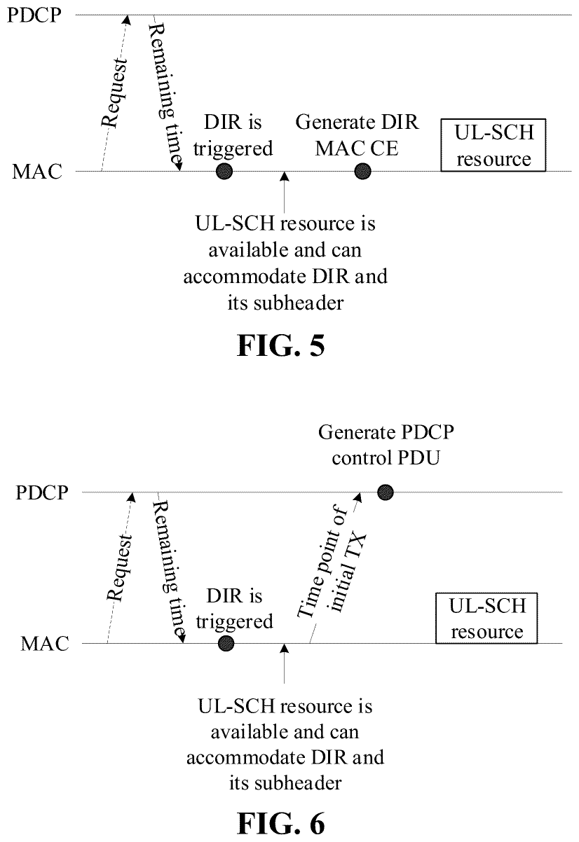

FIG. 5 is another schematic diagram in which a terminal equipment triggers and transmits delay information reporting in the embodiments of the present disclosure. FIG. 5 shows an interaction process between a PDCP layer and a MAC layer in a case where the delay information reporting is triggered at the MAC layer and is transmitted via a MAC CE.

In the above embodiments, as shown in FIG. 5, before the PDCP layer transfers the value of the discard timer or the value of the first remaining time to the MAC layer, the MAC layer optionally requests the PDCP layer to transfer the value of the at least one discard timer or the value of the at least one first remaining time.

In the above embodiments, as shown in FIG. 5, the MAC layer may further determine uplink resources before generating the delay information reporting MAC CE. For example, the MAC layer generates the delay information reporting MAC CE in a case of determining that a UL-SCH resource is available and is capable of accommodating the delay information reporting and a subheader of the delay information reporting.

In some embodiments, that the terminal equipment transmits the delay information reporting via a PDCP control PDU comprises:
the MAC layer determines the value of the second remaining time contained in the delay information reporting;
the MAC layer notifies the PDCP layer of the value of the second remaining time;
the PDCP layer generates a PDCP control PDU and transmits the delay information reporting to the network device via the PDCP control PDU, the delay information reporting containing the value of the second remaining time.

In the above embodiments, the value of the second remaining time is a value of a third timer corresponding to a time when the delay information reporting is transmitted for the first time, the third timer being a timer started by the MAC layer of the terminal equipment when receiving the value of the at least one discard timer or the value of the at least one first remaining time transferred by the PDCP layer.

In the embodiments of the present disclosure, the value of the second remaining time included in the delay information reporting may be one or more than one.

FIG. 6 is another schematic diagram in which a terminal equipment triggers and transmits delay information reporting in the embodiments of the present disclosure. FIG. 6 shows an interaction process between a PDCP layer and a MAC layer in a case where the delay information reporting is triggered at the MAC layer and is transmitted via a PDCP control PDU.

In the above embodiments, as shown in FIG. 6, before the PDCP layer transfers the value of the discard timer or the value of the first remaining time to the MAC layer, the MAC layer may further request the PDCP layer to transfer the value of the at least one discard timer or the value of the at least one first remaining time.

In the above embodiments, as shown in FIG. 6, the MAC layer may further determine uplink resources, for example the MAC layer notifies the PDCP layer of a time when the UL-SCH resource that may be used for initial transmission or new transmission is located in a case of determining that the UL-SCH resource is available and is capable of accommodating the delay information reporting and a subheader of the delay information reporting.

In the above embodiments, methods for triggering and transmitting the delay information reporting by a UE are described. In addition, in some situations, the UE may further not trigger or not transmit the delay information reporting.

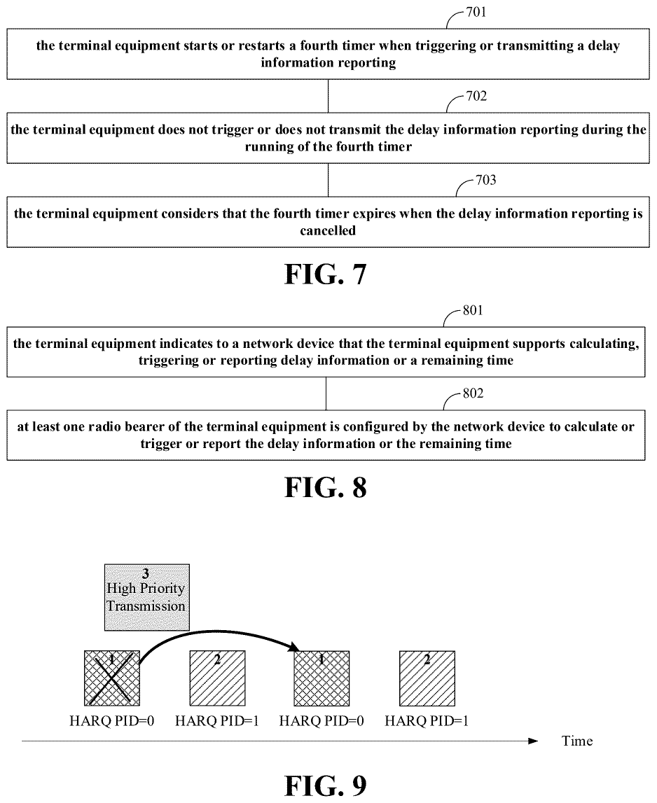

FIG. 7 is another schematic diagram of an information transmitting method in the embodiments of the present disclosure. FIG. 7 shows a situation where a UE does not trigger or does not transmit delay information reporting. As shown in FIG. 7, the method includes:
701: the terminal equipment starts or restarts a fourth timer when triggering or transmitting delay information reporting;
702: the terminal equipment does not trigger or does not transmit the delay information reporting during the running of the fourth timer; and
703: the terminal equipment considers that the fourth timer expires when the delay information reporting is cancelled.

It should be noted that the above FIG. 7 only schematically describes the embodiments of the present disclosure, but the present disclosure is not limited to this. For example, some other operations can be increased or operations therein may be reduced. Persons skilled in the art may make appropriate modifications according to the above contents, not limited to the records in the above FIG. 7.

In the above embodiments, the fourth timer may further be called “a prohibit timer”, which is used by the terminal equipment to perform operations related to delay information reporting. For example, the UE starts the fourth timer when triggering or transmitting the delay information reporting, does not trigger or transmit the delay information reporting during the running of the fourth timer, may trigger or transmit the delay information reporting again when the four timer expires, and may restart the fourth timer when triggering or transmitting the delay information reporting again.

In the above embodiments, a value of the fourth timer is predefined, or is configured by the network device.

In the above embodiments, the operations 702 and 703 are optional and will be respectively described below.

For example, the information transmitting method in the embodiments of the present disclosure may only include operation 701, which uses the fourth timer to time the triggering or transmission of the delay information reporting, and cancels or discards the triggering or transmission of the delay information reporting in case of expiry.

For another example, the information transmitting method in the embodiments of the present disclosure may include operations 701 and 702, which use the fourth timer to restrict a triggering period or transmission period of the delay information reporting. For example, the fourth timer is started when delay information reporting is triggered or transmitted, and during the running of the fourth timer, triggering or transmission of other delay information reporting is prohibited.

For another example, the information transmitting method in the embodiments of the present disclosure may further include operations 701 and 703, which use the fourth timer to restrict triggering or transmission of the delay information reporting. For example, when delay information reporting is triggered, the fourth timer is started. If the delay information reporting is cancelled within the time of the fourth timer, regardless of whether the fourth timer expires, the fourth timer is reset to expire, so to trigger the delay information reporting again as soon as possible.

For another example, the information transmitting method in the embodiments of the present disclosure may further include operations 701, 702 and 703, which use the fourth timer as a prohibit timer to restrict triggering or transmission of the delay information reporting. For example, the fourth timer is started when a delayed information reporting is triggered, and during the running of the fourth timer, triggering or transmission of other delay information reporting is prohibited, and in a case where the delay information reporting is cancelled within the time of the fourth timer, the fourth timer is reset to expire.

The above text describes that the terminal equipment triggers the delay information reporting and transmits the delay information reporting to the network device. According to the above embodiments, delay information reporting is triggered at a PDCP layer or MAC layer of a terminal equipment, and the delay information reporting is transmitted via a MAC CE or a PDCP control PDU, which helps the terminal equipment to timely transmit the delay information reporting to the network device.

The following text describes whether the terminal equipment supports calculating or triggering or reporting delay information. Delay information in the embodiments of the present disclosure may be delay information included in the delay information reporting, for example may include remaining time. Unless otherwise specified, “the delay information” described below refers to delay information included in the delay information reporting.

In some embodiments, the UE may actively report to make the network device know that the UE supports calculating, triggering or reporting delay information or remaining time, or the network device may configure for the UE to calculate or trigger or report the delay information or the remaining time.

The following text makes descriptions respectively.

In some embodiments, the UE actively reports that it supports calculating or triggering or reporting the delay information or the remaining time, for example the terminal equipment indicates to the network device that the terminal equipment supports calculating, triggering or reporting the delay information or the remaining time.

In the above embodiments, that the terminal equipment indicates to the network device that the terminal equipment supports calculating, triggering or reporting the delay information or the remaining time comprises at least one of the following:
the terminal equipment indicates to support calculating or triggering or reporting the delay information or the remaining time;
the terminal equipment indicates to support calculating or triggering or reporting the delay information or the remaining time by indicating a terminal type;
the terminal equipment indicates to support calculating or triggering or reporting the delay information or the remaining time by initiating a specific service; or
the terminal equipment indicates to support calculating or triggering or reporting the delay information or the remaining time by indicating that a PDCP discard timer lower than a ninth threshold is supported, or by indicating that an extended Discard Timer is supported, or by indicating that a Timer based SDU discard is supported.

In the above embodiments, the UE may directly indicate to support calculating or triggering or reporting the delay information or the remaining time by transmitting indication information to the network device; the UE may further indirectly indicate to support calculating or triggering or reporting the delay information or the remaining time by initiating a specific service.

The following text makes descriptions respectively.

In some embodiments, the UE indicates via indication information that the UE supports calculating or triggering or reporting delay information or remaining time, for example, indicates in a UE capability information message or an RRC setup complete message.

For example, the support of calculating or triggering or reporting delay information or remaining time may be indicated in a UE capability information message or an RRC setup complete message, and 1 bit may be used. For example, “1” indicates support, “0” indicates non-support, and vice versa, or presence of the 1 bit indicates support, and/or, absence of this bit indicates non-support, and vice versa. In addition, the calculation, triggering and reporting of the delay information or the remaining time may be indicated separately or in combination.

For another example, the UE may indicate a terminal type of the UE in indication information, the terminal type for example includes an XR UE. When the terminal type is an XR UE, it indicates that the UE supports calculating or triggering or reporting the delay information or the remaining time. For example, the terminal type may be indicated in a UE capability information message or an RRC setup complete message, and 1 bit may be used. For example, “1” indicates that the UE is an XR UE, that is, the calculating or triggering or reporting the delay information or the remaining time is supported, and “0” indicates that the UE is a non-XR UE, that is, the calculating or triggering or reporting the delay information or the remaining time is not supported, or presence of the 1 bit indicates that the UE is an XR UE, that is, the calculating or triggering or reporting the delay information or the remaining time is supported, and non-presence of this bit indicates that the UE is a non-XR UE, that is, the calculating or triggering or reporting the delay information or the remaining time is not supported.

For another example, the UE may indicate in indication information that it supports a PDCP discard timer lower than a ninth threshold, or supports an extended discard timer, or supports a Timer based SDU discard, and in a case of supporting the PDCP discard timer lower than a ninth threshold, or supporting the extended discard timer, or supporting the Timer based SDU discard, indicating that the calculating or triggering or reporting the delay information or the remaining time is supported. For example, the above contents may be indicated in a UE capability information message or an RRC setup complete message, and 1 bit may be used. For example, “1” indicates support, “0” indicates non-support, and vice versa, or presence of the 1 bit indicates support, absence of this bit indicates non-support, and vice versa.

In the above embodiments, when indicating to support the extended discard timer, a value of the supported extended discard timer, for example, includes 0.5 ms, 1 ms, 2 ms, 4 ms, 6 ms and 8 ms.

In some embodiments, the UE indirectly indicates to support calculating or triggering or reporting the delay information or the remaining time by initiating a specific service. The specific service for example includes an XR service and a latency-sensitive service. For example, a PDU set delay budget (PSDB) or a Packet delay budget (PDB) corresponding to QoS of a service is lower than a predetermined threshold, etc.

Thereby, by actively reporting the supporting calculating, triggering or reporting delay information or remaining time by the UE, a network device and the UE have a consistent understanding on whether the UE supports calculating, triggering or reporting the delay information or the remaining time, thus it is avoided an expected effect cannot be achieved due to that a network's expectation for delay information reporting is inconsistent with a UE capability, or a relevant configuration of a characteristic is configured for a UE that does not support the characteristic.

In some embodiments, the network device configures the UE to calculate or trigger or report delay information or remaining time, for example at least one radio bearer of the terminal equipment is configured by the network device to calculate or trigger or report the delay information or the remaining time.

In the above embodiments, that at least one radio bearer of the terminal equipment is configured by the network device to calculate or trigger or report the delay information or the remaining time comprises at least one of the following:
at least one radio bearer of the terminal equipment is configured by the network device to calculate or trigger or report the delay information or the remaining time;
at least one radio bearer (such as a DRB) of the terminal equipment is configured by the network device with an initial value of a PDCP discard timer (PDCP discardTimer) that is not infinity; or
at least one radio bearer of the terminal equipment is configured by the network device with an initial value of a PDCP discard timer lower than a tenth threshold.

In the above embodiments, for example, a network may configure using 1 bit. When this bit is configured to be 1, it indicates that the radio bearer calculates or triggers or reports delay information or remaining time, and when this bit is configured to be 0, it indicates that the radio bearer does not calculate or trigger or report the delay information or the remaining time, and vice versa; or, presence of this bit (for example, a value is “true”) indicates that the radio bearer calculates or triggers or reports the delay information or the remaining time; otherwise, it indicates that the radio bearer does not calculate or trigger or report the delay information or the remaining time.

Thereby, by configuring the UE by the network device to calculate or trigger or report the delay information or the remaining time, the network device and the UE have a consistent understanding on whether the UE supports calculating, triggering or reporting the delay information or the remaining time, thus it is avoided that an expected effect cannot be achieved due to that a network's expectation for delay information reporting is inconsistent with a UE capability, or a relevant configuration of a characteristic is configured for a UE that does not support the characteristic.

In some embodiments, the delay information reporting may be deprioritized possibly due to priority processing within the UE, and in a case where the UE is configured with autonomous transmission (or autonomousTX) or configured with a configured grant (CG) and the CG is configured as autonomous transmission, this deprioritization processing may cause the UE's understanding on a reference time of the remaining time in the delay information reporting to be inconsistent with the network device's understanding on the reference time of the remaining time in the received delay information reporting, thereby affecting scheduling of the network device.

To solve this problem, the terminal equipment may further transmit relevant information on the reference time of the remaining time in the delay information reporting to the network device. For example, the method may further include:
the terminal equipment transmits indication information to the network device, the indication information including at least one of the following information:
a point-in-time when the delay information reporting will be transmitted for the first time;
the delay information reporting is deprioritized in previous physical resources;
the delay information reporting is retransmitted; or
a time difference from a point-in-time when the delay information reporting will be transmitted for the first time to a current moment.

Thereby, the network device is able to correctly understand the reference time of the remaining time in the delay information reporting via the indication information.

In the above embodiments, the indication information for example is Uplink Control Information (UCI).

In the above embodiments, the point-in-time when the delay information reporting will be transmitted for the first time is a reference time of remaining time in the delay information reporting, so that regardless of whether the delay information reporting is deprioritized or not, the network device is able to obtain a correct scheduling deadline according to the point-in-time when receiving the delay information reporting.

In the above embodiments, by indicating to the network device that the delay information reporting is deprioritized in previous physical resources or that the delay information reporting is retransmitted, since the network device is able to infer a point-in-time of a physical resource for a CG of a previous identical HARQ process, therefore the network device is able to accurately understand the reference time of the remaining time in the delay information reporting, thereby obtaining a correct scheduling deadline.

In the above embodiments, by indicating to the network device a time difference from the point-in-time when the delay information reporting will be transmitted for the first time to a current moment, the network device is able to obtain the point-in-time when the delay information reporting will be transmitted for the first time according to the time difference, i.e. the reference time of the remaining time in the delay information reporting, thereby obtaining a correct scheduling deadline.

In some embodiments, a MAC PDU including the delay information reporting or including a delay information reporting MAC CE has the highest priority, for example with a value of 1; or, the delay information reporting has the highest priority. In this way, the MAC PDU including the delay information reporting MAC CE will not be deprioritized.

Thereby, the reference time of the remaining time in the delay information reporting is the time when the delay information reporting is transmitted. The scheduling deadline understood by the network device according to the remaining time in the delay information reporting is consistent with a deadline of service transmission of the UE.

In addition, when the MAC PDU including the delay information reporting MAC CE has the same priority as other MAC PDU, for example, the other MAC PDU includes logical channel data, wherein if a priority of the logical channel having the highest priority is the same as a priority of the MAC PDU including the delay information reporting MAC CE, or is the same as a priority of the delay information reporting MAC CE, the terminal equipment may give priority to transmitting this other MAC PDU, so as to give priority to ensuring transmission of user services, or the terminal equipment may further give priority to transmitting the MAC PDU including the delay information reporting MAC CE, so as to obtain an uplink grant for network scheduling XR-related data transmission as early as possible.

In some embodiments, if a sum of the remaining time included in the delay information reporting and a point-in-time of a next transmission of the delay information reporting exceeds a latency requirement of a service, the terminal equipment abandons transmitting the MAC PDU including the delay information reporting.

In some embodiments, if the delay information reporting is deprioritized, the terminal equipment discards or cancels the delay information reporting.

Thereby, the waste of resources caused by that the network device allocates resources that exceed latency requirements of services for the UE is avoided.

In some embodiments, the method may further include:
the terminal equipment regenerates delay information reporting for a next UL-SCH resource or uplink grant, a time reference point of the remaining time included in the regenerated delay information reporting is the next UL-SCH resource.

In the above embodiments, the next UL-SCH resource or uplink grant refers to a next UL-SCH resource or uplink grant that has the same HARQ process ID as a UL-SCH resource or uplink grant for which the delay information reporting is to be transmitted for the first time but is not transmitted, such as a next configured grant (CG) with the same HARQ process ID.

In some embodiments, the terminal equipment is not configured with autonomous transmission (or autonomousTx), the terminal equipment being a terminal equipment that performs delay information or remaining time calculation or triggering or reporting, or the terminal equipment is configured with autonomous transmission (or autonomousTx), the terminal equipment does not apply autonomous transmission to the delay information reporting.

In some embodiments, the CG configured to the terminal equipment is not configured with autonomous transmission (or autonomousTx), or the CG configured to the terminal equipment is configured with autonomous transmission but the terminal equipment does not transmit delay information reporting in a CG configured with autonomous transmission, or the terminal equipment does not transmit delay information reporting in a CG configured with autonomous transmission.

In some embodiments, the terminal equipment transmits delay information reporting in a dynamically scheduled uplink grant (dynamic grant, DG). The dynamically scheduled uplink grant may be indicated in a PDCCH addressing a C-RNTI of the terminal equipment. For example, the terminal equipment may transmit the delay information reporting without using a CG but only using a DG.

In the above embodiments, it may be stipulated in the standard that a terminal equipment that calculates, triggers or reports delay information or remaining time is not configured with autonomous transmission or is not configured with using a CG configured as autonomous transmission, or, it may be stipulated in the standard that a UE configured as autonomous transmission does not apply autonomous transmission to delay information reporting, or it may be stipulated in the standard that a UE does not transmit delay information reporting using a CG configured as autonomous transmission, or the UE transmits the delay information reporting using a dynamically scheduled uplink grant.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the method in the embodiments of the present disclosure, a PDCP layer or MAC layer of a terminal equipment triggers delay information reporting, and transmits the delay information reporting via a MAC CE or a PDCP control PDU, which helps the terminal equipment to timely transmit the delay information reporting to the network device, in addition, the network device may timely allocate appropriate uplink resources for transmission of an XR service according to contents of the delay information reporting, which helps meet latency requirements of the XR services, thereby ensuring QoS of the XR service, and may further improve a utilization rate of a radio resource.

### Embodiments of a Second Aspect

Inventor finds that the following application scenario may exist in practice: a network device expects a UE to transmit delay information reporting to the network device. Therefore, when configuring a DRB for the UE, a discard timer is configured in the DRB. However, some UEs may not support triggering or transmitting the delay information reporting, thus the network device may not receive expected delay information reporting, thereby leading to resource waste.

To solve the above technical problem, the embodiments of the present disclosure provide a communication method to determine whether a terminal equipment supports calculating or triggering or reporting delay information or remaining time, thereby helping improve a utilization rate of radio resources.

The following text describes the method from a terminal equipment side. FIG. 8 is a schematic diagram of a communication method in the embodiments of the present disclosure. As shown in FIG. 8, the method includes:
801: the terminal equipment indicates to a network device that the terminal equipment supports calculating, triggering or reporting delay information or remaining time; and
802: at least one radio bearer of the terminal equipment is configured by the network device to calculate or trigger or report the delay information or the remaining time.

It should be noted that the above FIG. 8 only schematically describes the embodiments of the present disclosure, but the present disclosure is not limited to this. For example, some other operations can be increased or operations therein may be reduced. Persons skilled in the art may make appropriate modifications according to the above contents, not limited to the records in the above FIG. 8.

According to the above embodiments, the network device and the UE have a consistent understanding on whether the UE supports calculating, triggering or reporting the delay information or the remaining time, thus it is avoided that an expected effect cannot be achieved due to that a network's expectation for delay information reporting is inconsistent with a UE capability, or a relevant configuration of a characteristic is configured for a UE that does not support the characteristic.

The delay information in the embodiments of the present disclosure may be delay information included in the delay information reporting, for example may include remaining time. Unless otherwise specified, “the delay information” described below refers to delay information included in the delay information reporting.

In the above embodiments, the network device may know that the UE supports calculating, triggering or reporting delay information or remaining time through actively reporting by the UE, or the network device may configure for the UE to calculate or trigger or report the delay information or the remaining time. That is to say, operation 801 and operation 802 may be executed separately or in combination, the embodiments of the present application do not impose limitations thereto.

The following text will provide a detailed description.

In 801, that the terminal equipment indicates to the network device that the terminal equipment supports calculating, triggering or reporting the delay information or the remaining time comprises at least one of the following:
the terminal equipment indicates to support calculating or triggering or reporting the delay information or the remaining time;
the terminal equipment indicates to support calculating or triggering or reporting the delay information or the remaining time by indicating a terminal type;
the terminal equipment indicates to support calculating or triggering or reporting the delay information or the remaining time by initiating a specific service; or
the terminal equipment indicates to support calculating or triggering or reporting the delay information or the remaining time by indicating that a PDCP discard timer lower than a ninth threshold is supported, or by indicating that an extended Discard Timer is supported, or by indicating that a Timer based SDU discard is supported.

In the above embodiments, the UE may directly indicate to support calculating or triggering or reporting the delay information or the remaining time by transmitting indication information to the network device; the UE may further indirectly indicate to support calculating or triggering or reporting the delay information or the remaining time by initiating a specific service.

The following text makes descriptions respectively.

In some embodiments, the UE indicates via indication information that the UE supports calculating or triggering or reporting delay information or remaining time, for example, indicates in a UE capability information message or an RRC setup complete message.

For example, the supporting calculating or triggering or reporting delay information or remaining time may be indicated in a UE capability information message or an RRC setup complete message, and 1 bit may be used. For example, “1” indicates support, “0” indicates non-support, and vice versa, or presence of the 1 bit indicates support, and/or, absence of this bit indicates non-support, and vice versa. In addition, for calculation, triggering and reporting of the delay information or the remaining time, they may be indicated separately or in combination.

For another example, the UE may indicate a terminal type of the UE in the indication information, the terminal type for example includes an XR UE. When the terminal type is an XR UE, it indicates that the UE supports calculating or triggering or reporting the delay information or the remaining time. For example, the terminal type may be indicated in a UE capability information message or an RRC setup complete message, and 1 bit may be used. For example, “1” indicates that the UE is an XR UE, that is, calculating or triggering or reporting the delay information or the remaining time is supported, and “0” indicates that the UE is a non-XR UE, that is, calculating or triggering or reporting the delay information or the remaining time is not supported, or presence of the 1 bit indicates that the UE is an XR UE, that is, calculating or triggering or reporting the delay information or the remaining time is supported, and non-presence of this bit indicates that the UE is a non-XR UE, that is, calculating or triggering or reporting the delay information or the remaining time is not supported.

For another example, the UE may indicate in the indication information that it supports a PDCP discard timer lower than a ninth threshold, or supports an extended discard timer, or supports a Timer based SDU discard, and in a case of supporting the PDCP discard timer lower than a ninth threshold, or supporting the extended discard timer, or supporting the Timer based SDU discard, indicating that the calculating or triggering or reporting the delay information or the remaining time is supported. For example, the above contents may be indicated in a UE capability information message or an RRC setup complete message, and 1 bit may be used. For example, “1” indicates support, “0” indicates non-support, and vice versa, or presence of the 1 bit indicates support, absence of this bit indicates non-support, and vice versa.

In the above embodiments, when indicating to support the extended discard timer, a value of the supported extended discard timer, for example, includes 0.5 ms, 1 ms, 2 ms, 4 ms, 6 ms and 8 ms. Embodiments of the present disclosure do not impose limitations thereto.

In some embodiments, the UE indirectly indicates to support calculating or triggering or reporting the delay information or the remaining time by initiating a specific service. The specific service for example includes an XR service and a latency-sensitive service. For example, a PDU set delay budget (PSDB) or a Packet delay budget (PDB) corresponding to QoS of a service is lower than a predetermined threshold, etc.

In 802, that at least one radio bearer of the terminal equipment is configured by the network device to calculate or trigger or report the delay information or the remaining time comprises at least one of the following:
at least one radio bearer of the terminal equipment is configured by the network device to calculate or trigger or report the delay information or the remaining time;
at least one radio bearer (such as a DRB) of the terminal equipment is configured by the network device with an initial value of a PDCP discard timer (PDCP discardTimer) that is not infinity; or
at least one radio bearer of the terminal equipment is configured by the network device with an initial value of a PDCP discard timer lower than a tenth threshold.

In the above embodiments, for example, a network may configure using 1 bit. When this bit is configured to be 1, it indicates that the radio bearer calculates or triggers or reports delay information or remaining time, and when this bit is configured to be 0, it indicates that the radio bearer does not calculate or trigger or report the delay information or the remaining time, and vice versa; or, presence of this bit (for example, a value is “true”) indicates that the radio bearer calculates or triggers or reports the delay information or the remaining time; otherwise, it indicates that the radio bearer does not calculate or trigger or report the delay information or the remaining time.

A value of the tenth threshold may be pre-set or be configured by the network device, the present disclosure does not impose limitations on their values and configuring methods.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the method in the embodiments of the present disclosure, the network device and the UE have a consistent understanding on whether the UE supports calculating, triggering or reporting the delay information or the remaining time, such that it is avoided that an expected effect cannot be achieved due to that a network's expectation for delay information reporting is inconsistent with a UE capability, or a relevant configuration of a characteristic is configured for a UE that does not support the characteristic.

### Embodiments of a Third Aspect

Inventor finds that priority processing within a UE will affect accuracy of remaining time included in delay information reporting. FIG. 9 is a schematic diagram of priority processing within a UE.

As shown in FIG. 9, a MAC PDU including the delay information reporting will be transmitted in a first physical resource 1 (such as a PUSCH), for example, physical resource 1 using HARQ process ID 0. The reference time of the remaining time included in the delay information reporting is time when the remaining time is transmitted for the first time, i.e., time of the first physical resource 1. This physical resource may be a physical resource corresponding to a configured grant (CG).

Assuming that there exists another physical resource 3 that overlaps with the first physical resource 1, there is high-priority transmission to be transmitted in the physical resource 3, therefore the MAC PDU in the first physical resource 1 is regarded as low-priority (deprioritized) transmission and is not actually transmitted. Furthermore, assuming that in a second physical resource 1 corresponding to a next HARQ process ID 0, this MAC PDU may be transmitted for the first time.

Then, when a gNB receives a MAC PDU in the second physical resource 1, since it is unaware that this MAC PDU was once deprioritized, the gNB considers that the reference time of the remaining time included in this MAC PDU is time corresponding to the second physical resource 1.

That is to say, when the MAC PDU is received by a network device via the second physical resource 1, the gNB understands that a deadline for scheduling is a point-in-time of the second physical resource 1 plus the remaining time included in the delay information reporting, while in a UE side, a deadline for actual service transmission is a point-in-time of the first physical resource 1 plus the remaining time included in the delay information reporting, hence the gNB may allocate an uplink grant (UL grant) that is later than the deadline for service transmission in the UE, resulting in failure to meet QoS requirements of XR service or data loss, thereby leading to a decline in user experience. Therefore, enabling the network device to correctly understand the reference time of the remaining time included in the delay information reporting is helpful for the network device to perform correct scheduling.

To solve the above technical problem, the embodiments of the present disclosure provide an information transmitting method, so that the network device is able to correctly understand the reference time of the remaining time included in the delay information reporting.

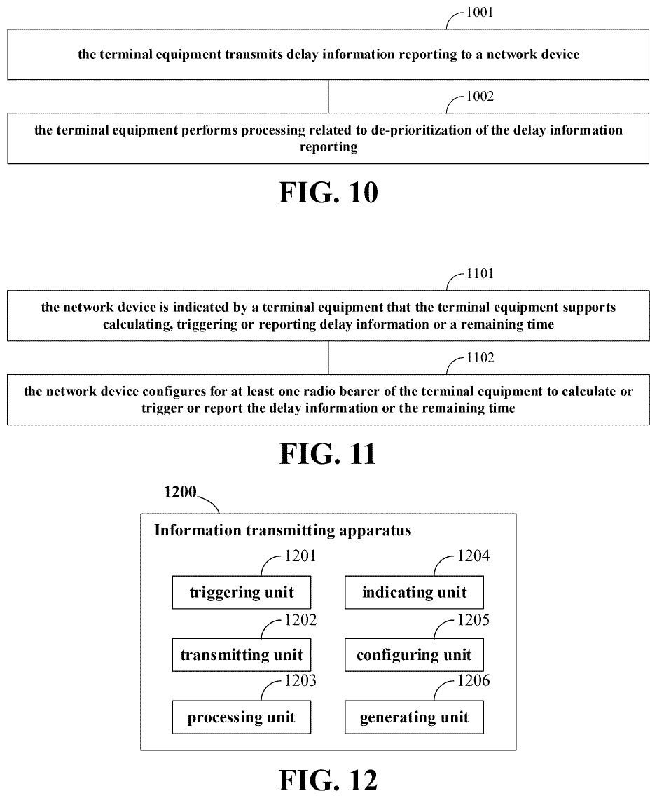

The following text describes the method from a terminal equipment side. FIG. 10 is a schematic diagram of an information transmitting method in the embodiments of the present disclosure. As shown in FIG. 10, the method includes:
1001: the terminal equipment transmits delay information reporting to a network device; and
1002: the terminal equipment performs processing related to de-prioritization of the delay information reporting.

It should be noted that the above FIG. 10 only schematically describes the embodiments of the present disclosure, but the present disclosure is not limited to this. For example, some other operations can be increased or operations therein may be reduced. Persons skilled in the art may make appropriate modifications according to the above contents, not limited to the records in the above FIG. 10.

In the above embodiments, in 1002, that the terminal equipment performs processing related to de-prioritization of the delay information reporting comprises:
the terminal equipment transmits first indication information to the network device, the first indication information including at least one of the following information:
a point-in-time when the delay information reporting will be transmitted for the first time;
the delay information reporting is deprioritized in previous physical resource;
the delay information reporting is retransmitted; or
a time difference from a point-in-time when the delay information reporting will be transmitted for the first time to a current moment.

Thereby, the network device is able to correctly understand the reference time of the remaining time in the delay information reporting via the indication information.

In the above embodiments, the point-in-time when the delay information reporting will be transmitted for the first time is a reference time of remaining time in the delay information reporting, for example the point-in-time is time of the first physical resource 1 shown in FIG. 9, so that regardless of whether the delay information reporting is deprioritized or not, the network device is able to obtain a correct scheduling deadline according to the point-in-time when receiving the delay information reporting.

In the above embodiments, by indicating to the network device that the delay information reporting is deprioritized in previous physical resources or that the delay information reporting is retransmitted, since the network device is able to infer a point-in-time of a physical resource for a CG of a previous identical HARQ process, therefore the network device is able to accurately understand the reference time of the remaining time in the delay information reporting, thereby obtaining a correct scheduling deadline.

In the above embodiments, by indicating to the network device a time difference from the point-in-time when the delay information reporting will be transmitted for the first time to a current moment, so that the network device is able to obtain the point-in-time when the delay information reporting will be transmitted for the first time according to the time difference, i.e. the reference time of the remaining time in the delay information reporting, thereby obtaining a correct scheduling deadline.

In some embodiments, in 1002, that the terminal equipment performs processing related to de-prioritization of the delay information reporting comprises:
the terminal equipment considers that a MAC PDU including the delay information reporting or including a delay information reporting MAC CE has the highest priority, for example with a value of 1; or, the delay information reporting has the highest priority. In this way, the MAC PDU including the delay information reporting MAC CE will not be deprioritized.

Thereby, the reference time of the remaining time in the delay information reporting is the time when the delay information reporting is transmitted. The scheduling deadline understood by the network device according to the remaining time in the delay information reporting is consistent with a deadline for service transmission of the UE.

In addition, when the MAC PDU including the delay information reporting MAC CE has the same priority as other MAC PDU, for example, the other MAC PDU includes data of a logical channel, wherein if a priority of the logical channel having the highest priority is the same as a priority of the MAC PDU including the delay information reporting MAC CE, or is the same as a priority of the delay information reporting MAC CE, the terminal equipment may give priority to transmitting this other MAC PDU, so as to give priority to ensuring transmission of user services, or the terminal equipment may further give priority to transmitting the MAC PDU including the delay information reporting MAC CE, so as to obtain an uplink grant for network scheduling XR-related data transmission as early as possible.

In some embodiments, in 1002, that the terminal equipment performs processing related to de-prioritization of the delay information reporting comprises:
in a case where a sum of the remaining time included in the delay information reporting and a point-in-time of a next transmission of the delay information reporting exceeds a latency requirement of a service, the terminal equipment abandons transmitting the MAC PDU including the delay information reporting.

In some embodiments, in 1002, that the terminal equipment performs processing related to de-prioritization of the delay information reporting comprises:
in a case where the delay information reporting is deprioritized, the terminal equipment discards or cancels the delay information reporting.

Thereby, the waste of resources caused by that the network device allocates resources that exceed latency requirements of services for the UE is avoided.

In some embodiments, the method further includes:
the terminal equipment regenerates delay information reporting for a next UL-SCH resource or uplink grant, a time reference point of the remaining time included in the regenerated delay information reporting is the next UL-SCH resource.

In the above embodiments, the next UL-SCH resource or uplink grant refers to a next UL-SCH resource or uplink grant that has the same HARQ process ID as a UL-SCH resource or uplink grant for which the delay information reporting is to be transmitted for the first time but is not transmitted, such as a next configured grant (CG) with the same HARQ process ID.

In some embodiments, in 1002, that the terminal equipment performs processing related to de-prioritization of the delay information reporting comprises:
the terminal equipment considers not to be configured with autonomous transmission (or autonomousTx), or,
the terminal equipment considers to be configured with autonomous transmission, and the terminal equipment does not apply autonomous transmission to the delay information reporting.

In some embodiments, in 1002, that the terminal equipment performs processing related to de-prioritization of the delay information reporting comprises:
the terminal equipment considers that a configured configured grant is not configured with autonomous transmission, or
the terminal equipment does not transmit the delay information reporting in a configured grant configured with autonomous transmission.

In some embodiments, the terminal equipment considers that a configured configured grant is configured with autonomous transmission, and the terminal equipment does not transmit the delay information reporting in a configured grant configured with autonomous transmission.

In some embodiments, in 1001, the terminal equipment transmits the delay information reporting in a dynamically scheduled uplink grant (dynamic grant, DG). The dynamically scheduled uplink grant may be indicated in a PDCCH addressing a C-RNTI of the terminal equipment. For example, the terminal equipment may transmit the delay information reporting without using a CG but only using a DG.

In the above embodiments, it may be stipulated in the standard that a terminal equipment that calculates, triggers or reports delay information or remaining time is not configured with autonomous transmission or is not configured with using a CG configured as autonomous transmission, or, it may be stipulated in the standard that a UE configured as autonomous transmission does not apply autonomous transmission to delay information reporting, or it may be stipulated in the standard that a UE does not transmit the delay information reporting using a CG configured as autonomous transmission, or the UE transmits the delay information reporting using a dynamically scheduled uplink grant.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the method in the embodiments of the present disclosure, the network device is able to correctly understand the reference time of the remaining time included in the delay information reporting transmitted by the terminal equipment, which is helpful for the network device to perform correct scheduling.

### Embodiments of a Fourth Aspect

Embodiments of the present disclosure provide a communication method, which is described from a network device side, the contents that repeats with the embodiments of the second aspect are not be further elaborated.

FIG. 11 is a schematic diagram of a communication method in the embodiments of the present disclosure. As shown in FIG. 11, the communication method includes:
1101: the network device is indicated by a terminal equipment that the terminal equipment supports calculating, triggering or reporting delay information or remaining time; and
1102: the network device configures for at least one radio bearer of the terminal equipment to calculate or trigger or report the delay information or the remaining time.

The delay information in the embodiments of the present disclosure may be delay information included in the delay information reporting, for example may include remaining time. Unless otherwise specified, the “delay information” described below refers to delay information included in the delay information reporting.

In some embodiments, in 1101, that the network device is indicated by a terminal equipment that the terminal equipment supports calculating, triggering or reporting delay information or remaining time comprises at least one of the following:
the terminal equipment indicates to support calculating or triggering or reporting the delay information or the remaining time;
the terminal equipment indicates to support calculating or triggering or reporting the delay information or the remaining time by indicating a terminal type;
the terminal equipment indicates to support calculating or triggering or reporting the delay information or the remaining time by initiating a specific service; or
the terminal equipment indicates to support calculating or triggering or reporting the delay information or the remaining time by indicating that a PDCP discard timer lower than a first threshold is supported, or by indicating that an extended Discard Timer is supported, or by indicating that a Timer based SDU discard is supported.

In some embodiments, in 1102, that the network device configures for at least one radio bearer of the terminal equipment to calculate or trigger or report the delay information or the remaining time comprises at least one of the following:
the network device configures for at least one radio bearer of the terminal equipment to calculate or trigger or report the delay information or the remaining time; and/or,
the network device configures an initial value of a PDCP discard timer (PDCP discardTimer) that is not infinity, for at least one radio bearer of the terminal equipment; and/or,
the network device configures an initial value of a PDCP discard timer (discardTimer) lower than a second threshold, for at least one radio bearer of the terminal equipment.

In addition, operation 1101 and operation 1102 may be executed separately or in combination, the embodiments of the present application do not impose limitations thereto.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the method in the embodiments of the present disclosure, the network device and the UE have a consistent understanding on whether the UE supports calculating, triggering or reporting the delay information or the remaining time, such that it is avoided that an expected effect cannot be achieved due to that a network's expectation for delay information reporting is inconsistent with a UE capability, or a relevant configuration of a characteristic is configured for a UE that does not support the characteristic.

### Embodiments of a Fifth Aspect

Embodiments of the present disclosure provide an information transmitting apparatus. The apparatus may, for example, be a terminal equipment, or may be one or more parts or components configured in the terminal equipment. The apparatus in the embodiments of the present disclosure corresponds to the method in the embodiments of the first aspect, the contents same as those in the embodiments of the first aspect are not repeated.

FIG. 12 is a schematic diagram of an example of an information transmitting apparatus in the embodiments of the present disclosure. As shown in FIG. 12, the information transmitting apparatus 1200 in the embodiments of the present disclosure comprises:
a triggering unit 1201, configured to trigger delay information reporting at a PDCP layer or MAC layer of the terminal equipment; and
a transmitting unit 1202, configured to transmit the delay information reporting to a network device via a MAC CE or a PDCP control PDU.

In some embodiments, that the triggering unit 1201 triggers delay information reporting at a PDCP layer of the terminal equipment comprises at least one of the following:
if a value of a discard timer or a value of a first remaining time associated with a PDCP SDU in the PDCP entity is lower than a first threshold, the PDCP entity triggers the delay information reporting;
if a minimum value of a discard timer or of a first remaining time associated with all PDCP SDUs in the PDCP entity is lower than a second threshold, the PDCP entity triggers the delay information reporting;
if a minimum value of a discard timer or of a first remaining time associated with all PDCP SDUs in a PDCP entity associated with a DRB established by the terminal equipment or configured for the terminal equipment is lower than a third threshold, the PDCP layer of the terminal equipment triggers the delay information reporting;
the PDCP layer of the terminal equipment periodically triggers the delay information reporting; or
the PDCP layer of the terminal equipment triggers the delay information reporting when a new PDU set reaches the PDCP layer.

In the above embodiments, a period during which the PDCP layer of the terminal equipment triggers the delay information reporting is predefined or is configured by the network device.

In some embodiments, that the transmitting unit 1202 transmits the delay information reporting via a MAC CE comprises:
the PDCP layer of the terminal equipment transfers the value of the discard timer or the value of the first remaining time to the MAC layer;
the MAC layer of the terminal equipment determines a value of a second remaining time according to the value of the discard timer or the value of the first remaining time; and
the MAC layer of the terminal equipment generates a delay information reporting MAC CE and transmits the delay information reporting MAC CE to the network device, the delay information reporting MAC CE containing the value of the second remaining time.

In the above embodiments, the value of the second remaining time is a value of remaining time corresponding to a time when the delay information reporting is transmitted for the first time.

In the above embodiments, that the MAC layer of the terminal equipment determines a value of a second remaining time according to the value of the discard timer or the value of the first remaining time comprises:
the MAC layer of the terminal equipment starts a first timer upon receiving the value of the discard timer or the value of the first remaining time transferred by the PDCP layer, the value of the first timer being set to be the value of the discard timer or the value of the first remaining time transferred by the PDCP layer; and
the MAC layer of the terminal equipment determines the value of the second remaining time according to the value of the first timer, the value of the second remaining time being a value of the first timer corresponding to a time when the delay information report is transmitted for the first time.

In some embodiments, that the transmitting unit 1202 transmits the delay information reporting via a MAC CE further comprises:
the PDCP layer of the terminal equipment indicates to the MAC layer that delay information reporting is triggered, and/or,
the PDCP layer of the terminal equipment indicates the MAC layer to generate a delay information reporting MAC CE.

In the above embodiments, that the transmitting unit 1202 transmits the delay information reporting via a MAC CE further comprises:
the MAC layer of the terminal equipment generates the delay information reporting MAC CE in a case of determining that a UL-SCH resource is available and is capable of accommodating the delay information reporting and a subheader of the delay information reporting.

In some embodiments, that the transmitting unit 1202 transmits the delay information reporting via a PDCP control PDU comprises:
the MAC layer of the terminal equipment notifies the PDCP layer of a time when a UL-SCH resource that may be used for initial transmission or new transmission of the delay information reporting is located;
the PDCP layer of the terminal equipment determines a value of a second remaining time according to a time when the UL-SCH resource is located;
the PDCP layer of the terminal equipment generates a PDCP control PDU and transmits the delay information reporting to the network device via the PDCP control PDU, the delay information reporting containing the value of the second remaining time.

In the above embodiments, that the transmitting unit 1202 transmits the delay information reporting via a PDCP control PDU further comprises:
the MAC layer of the terminal equipment notifies the PDCP layer of a time when the UL-SCH resource that may be used for initial transmission or new transmission is located in a case of determining that the UL-SCH resource is available and is capable of accommodating the delay information reporting and a subheader of the delay information reporting.

In some embodiments, that the transmitting unit 1202 transmits the delay information reporting via a PDCP control PDU comprises:
the MAC layer of the terminal equipment determines a value of a second remaining time contained in the delay information reporting;
the MAC layer of the terminal equipment notifies the PDCP layer of the value of the second remaining time;
the PDCP layer of the terminal equipment generates a PDCP control PDU and transmits the delay information reporting to the network device via the PDCP control PDU, the delay information reporting containing the value of the second remaining time.

In the above embodiments, that the MAC layer of the terminal equipment determines the value of the second remaining time contained in the delay information reporting comprises:
the PDCP layer of the terminal equipment transfers the value of the discard timer or the value of the first remaining time to the MAC layer;
the MAC layer of the terminal equipment starts a second timer upon receiving the value of the discard timer or the value of the first remaining time transferred by the PDCP layer, the value of the second timer being set to be the value of the discard timer or the value of the first remaining time transferred by the PDCP layer; and
the MAC layer of the terminal equipment determines a value of a second remaining time according to the value of the second timer, the value of the second remaining time being a value of the second timer corresponding to a time when the delay information reporting is transmitted for the first time.

In the above embodiments, that the transmitting unit 1202 transmits the delay information reporting via a PDCP control PDU further comprises:
the PDCP layer of the terminal equipment indicates to the MAC layer that delay information reporting is triggered.

In some embodiments, that the triggering unit 1201 triggers the delay information reporting at the MAC layer of the terminal equipment comprises:
the PDCP layer of the terminal equipment transfers a value of at least one discard timer or a value of at least one first remaining time associated with the PDCP SDU in the PDCP entity to the MAC layer; and
the MAC layer of the terminal equipment determines whether to trigger the delay information reporting according to the value of the at least one discard timer or the value of the at least one first remaining time.

In the above embodiments, the MAC layer of the terminal equipment triggers the delay information reporting when the value of the at least one discard timer or the value of the at least one first remaining time is less than an eleventh threshold.

In the above embodiments, the PDCP entity of the terminal equipment obtains a minimum value of the discard timers or the first remaining times associated with all PDCP SDUs in the PDCP entity, and transfers the minimum values to the MAC layer; and
the MAC layer of the terminal equipment triggers the delay information reporting when a minimum value in the minimum values transmitted by all PDCP entities is less than a fourth threshold.

In the above embodiments, the PDCP layer of the terminal equipment transfers a minimum value of the discard timers or the first remaining times associated with all PDCP SDUs to the MAC layer; and
the MAC layer of the terminal equipment triggers the delay information reporting when the minimum value is less than a fifth threshold.

In the above embodiments, the PDCP entity or the PDCP layer of the terminal equipment transfers the value of the more than one discard timer or the value of the more than one first remaining time to the MAC layer; and
the MAC layer of the terminal equipment triggers the delay information reporting when a minimum value in the value of the more than one discard timer or the value of the more than one first remaining time is less than a sixth threshold.

In some embodiments, that the triggering unit 1201 triggers delay information reporting at the MAC layer of the terminal equipment comprises:
the MAC layer of the terminal equipment obtains a value of at least one discard timer or a value of at least one first remaining time; and
the MAC layer of the terminal equipment determines whether to trigger the delay information reporting according to the value of the at least one discard timer or the value of the at least one first remaining time.

In the above embodiments, the MAC layer of the terminal equipment triggers the delay information reporting when a minimum value in the value of the at least one discard timer or the value of the at least one first remaining time is less than a seventh threshold.

In the above embodiments, the MAC layer of the terminal equipment triggers the delay information reporting when the value of the at least one discard timer or the value of the at least one first remaining time is less than a seventh threshold.

In the above embodiments, that the MAC layer of the terminal equipment determines whether to trigger the delay information reporting according to the value of the at least one discard timer or the value of the at least one first remaining time comprises:
the MAC layer of the terminal equipment starts a third timer upon receiving the value of the discard timer or the value of the first remaining time transferred by the PDCP layer, the value of the third timer being set to be the value of the discard timer or the value of the first remaining time transferred by the PDCP layer; and
triggers the delay information reporting when the value of the third timer is lower than an eighth threshold.

In some embodiments, that the transmitting unit 1202 transmits the delay information reporting via a MAC CE comprises:
the MAC layer of the terminal equipment determines a value of a second remaining time according to the value of the at least one discard timer or the value of the at least one first remaining time; and
the MAC layer of the terminal equipment generates a delay information reporting MAC CE and transmits the delay information reporting MAC CE to the network device, the delay information reporting MAC CE containing the value of the second remaining time.

In the above embodiments, the value of the second remaining time is a value of remaining time corresponding to a time when the delay information reporting is transmitted for the first time; or,
the value of the second remaining time is a value of a third timer corresponding to a time when the delay information reporting is transmitted for the first time, the third timer being a timer started by the MAC layer of the terminal equipment when receiving the value of the at least one discard timer or the value of the at least one first remaining time transferred by the PDCP layer.

In the above embodiments, that the transmitting unit 1202 transmits the delay information reporting via a MAC CE further comprises:
the MAC layer of the terminal equipment requests the PDCP layer to transfer the value of the at least one discard timer or the value of the at least first remaining time.

In the above embodiments, that the transmitting unit 1202 transmits the delay information reporting via a MAC CE further comprises:
the MAC layer of the terminal equipment generates the delay information reporting MAC CE in a case of determining that a UL-SCH resource is available and is capable of accommodating the delay information reporting and a subheader of the delay information reporting.

In some embodiments, that the transmitting unit 1202 transmits the delay information reporting via a PDCP control PDU comprises:
the MAC layer of the terminal equipment determines a value of a second remaining time contained in the delay information reporting;
the MAC layer of the terminal equipment notifies the PDCP layer of the value of the second remaining time;
the PDCP layer of the terminal equipment generates a PDCP control PDU and transmits the delay information reporting to the network device via the PDCP control PDU, the delay information reporting containing the value of the second remaining time.

In the above embodiments, that the transmitting unit 1202 transmits the delay information reporting via a PDCP control PDU further comprises:
the MAC layer of the terminal equipment requests the PDCP layer to transfer the value of the at least one discard timer or the value of the at least first remaining time.

In the above embodiments, the value of the second remaining time is a value of a third timer corresponding to a time when the delay information reporting is transmitted for the first time, the third timer being a timer started by the MAC layer of the terminal equipment when receiving the value of the at least one discard timer or the value of the at least one first remaining time transferred by the PDCP layer.

In the above embodiments, that the transmitting unit 1202 transmits the delay information reporting via a PDCP control PDU further comprises:
the MAC layer of the terminal equipment notifies the PDCP layer of a time when the UL-SCH resource that may be used for initial transmission or new transmission is located in a case of determining that the UL-SCH resource is available and is capable of accommodating the delay information reporting and a subheader of the delay information reporting.

In some embodiments, as shown in FIG. 12, the apparatus 1200 further comprises a processing unit 1203. The processing unit 1203 starts or restarts a fourth timer when the triggering unit 1201 triggers delay information reporting or when the transmitting unit 1203 transmits delay information reporting; and/or, does not trigger or does not transmit the delay information reporting during running of the fourth timer; and/or, considers that the fourth timer expires when the delay information reporting is cancelled.

In the above embodiments, a value of the fourth timer is predefined, or is configured by the network device.

In some embodiments, the apparatus 1200 further comprises an indicating unit 1204 and/or a configuring unit 1205, the indicating unit 1204 indicates to the network device that the terminal equipment supports calculating or triggering or reporting delay information or remaining time, and the configuring unit 1205 is configured by the network device with at least one radio bearer to calculate or trigger or report the delay information or the remaining time.

In some embodiments, that the indicating unit 1204 indicates to the network device that the terminal equipment supports calculating, triggering or reporting the delay information or the remaining time comprises at least one of the following:
the terminal equipment indicates to support calculating or triggering or reporting the delay information or the remaining time;
the terminal equipment indicates to support calculating or triggering or reporting the delay information or the remaining time by indicating a terminal type;
the terminal equipment indicates to support calculating or triggering or reporting the delay information or the remaining time by initiating a specific service; or
the terminal equipment indicates to support calculating or triggering or reporting the delay information or the remaining time by indicating that a PDCP discard timer lower than a ninth threshold is supported, or by indicating that an extended Discard Timer is supported, or by indicating that a Timer based SDU discard is supported.

In some embodiments, that the configuring unit 1205 is configured by the network device with at least one radio bearer to calculate or trigger or report the delay information or the remaining time comprises at least one of the following:
at least one radio bearer of the terminal equipment is configured by the network device to calculate or trigger or report the delay information or the remaining time;
at least one radio bearer of the terminal equipment is configured by the network device with an initial value of a PDCP discard timer (discardTimer) that is not infinity; or
at least one radio bearer of the terminal equipment is configured by the network device with an initial value of a PDCP discard timer (discardTimer) lower than a tenth threshold.

In some embodiments, that the transmitting unit 1202 further transmits indication information to the network device, the indication information including at least one of the following information:
a point-in-time when the delay information reporting will be transmitted for the first time;
the delay information reporting is deprioritized in previous physical resource;
the delay information reporting is retransmitted; or
a time difference from a point-in-time when the delay information reporting will be transmitted for the first time to a current moment.

In some embodiments, a MAC PDU including the delay information reporting or including a delay information reporting MAC CE has the highest priority; or, the delay information reporting has the highest priority.

In some embodiments, if a sum of the remaining time included in the delay information reporting and a point-in-time of a next transmission of the delay information reporting exceeds a latency requirement of a service, the terminal equipment abandons transmitting the MAC PDU including the delay information reporting.

In some embodiments, if the delay information reporting is deprioritized, the terminal equipment discards or cancels the delay information reporting.

In the above embodiments, the apparatus 1200 further comprises:
a generating unit 1206, configured to regenerate delay information reporting for a next UL-SCH resource or uplink grant, a time reference point of the remaining time included in the regenerated delay information reporting is the next UL-SCH resource.

In some embodiments, the terminal equipment is not configured with autonomous transmission (or autonomousTx), the terminal equipment being a terminal equipment that performs delay information calculation or triggering or reporting, or the terminal equipment is configured with autonomous transmission (or autonomousTx), the terminal equipment does not apply autonomous transmission to the delay information reporting.

In some embodiments, the CG configured to the terminal equipment is not configured with autonomous transmission (or autonomousTx), or the CG configured to the terminal equipment is configured with autonomous transmission but the terminal equipment does not transmit delay information reporting in a CG configured with autonomous transmission, or the terminal equipment does not transmit delay information reporting in a CG configured with autonomous transmission.

In some embodiments, the terminal equipment transmits delay information reporting in a dynamically scheduled uplink grant (DG). The dynamically scheduled uplink grant may be indicated in a PDCCH addressing a C-RNTI of the terminal equipment, for example the terminal equipment may not transmit the delay information reporting in a CG and transmits the delay information reporting only in a DG.

Embodiments of the present disclosure further provide a communication apparatus. The apparatus may, for example, be a terminal equipment, or may be one or more parts or components configured in the terminal equipment. The apparatus in the embodiments of the present disclosure corresponds to the method in the embodiments of the second aspect, the contents same as those in the embodiments of the second aspect are not repeated.

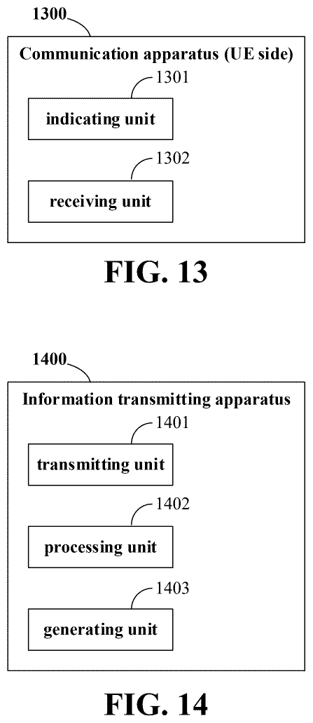

FIG. 13 is a schematic diagram of an example of a communication apparatus in the embodiments of the present disclosure. As shown in FIG. 13, the communication apparatus 1300 in the embodiment of the present disclosure comprises an indicating unit 1301 and/or a receiving unit 1302, the indicating unit 1301 indicates to the network device that the terminal equipment supports calculating, triggering or reporting delay information or remaining time, the receiving unit 1302 receives configuration information from the network device, the configuration information being used to configure to calculate or trigger or report the delay information or the remaining time for at least one radio bearer of the terminal equipment.

In some embodiments, that the indicating unit 1301 indicates to the network device that the terminal equipment supports calculating, triggering or reporting the delay information or the remaining time comprises at least one of the following:
indicating to support calculating or triggering or reporting the delay information or the remaining time;
indicating to support calculating or triggering or reporting the delay information or the remaining time by indicating a terminal type;
indicating to support calculating or triggering or reporting the delay information or the remaining time by initiating a specific service; or
indicating to support calculating or triggering or reporting the delay information or the remaining time by indicating that a PDCP discard timer lower than a first threshold is supported, or by indicating that an extended Discard Timer is supported, or by indicating that a Timer based SDU discard is supported.

In some embodiments, that the configuration information is used to configure to calculate or trigger or report the delay information or the remaining time for at least one radio bearer of the terminal equipment comprises at least one of the following:
at least one radio bearer of the terminal equipment is configured to calculate or trigger or report the delay information or the remaining time; and/or,
at least one radio bearer of the terminal equipment is configured with an initial value of a PDCP discard timer (PDCP discardTimer) that is not infinity; and/or,
at least one radio bearer of the terminal equipment is configured with an initial value of a PDCP discard timer (discardTimer) lower than a second threshold.

Embodiments of the present disclosure further provide an information transmitting apparatus. The apparatus may, for example, be a terminal equipment, or may be one or more parts or components configured in the terminal equipment. The apparatus in the embodiments of the present disclosure corresponds to the method in the embodiments of the third aspect, the contents same as those in the embodiments of the third aspect are not repeated.

FIG. 14 is a schematic diagram of an example of an information transmitting apparatus in the embodiments of the present disclosure. As shown in FIG. 14, the apparatus 1400 comprises a transmitting unit 1401 and a processing unit 1402, the transmitting unit 1401 transmits delay information reporting to a network device; the processing unit 1402 performs processing related to de-prioritization of the delay information reporting.

In some embodiments, that the processing unit 1402 performs processing related to de-prioritization of the delay information reporting comprises:
transmitting first indication information to a network device, the first indication information including at least one of the following information:
a point-in-time when the delay information reporting will be transmitted for the first time;
the delay information reporting is deprioritized in previous physical resource;
the delay information reporting is retransmitted; or
a time difference from a point-in-time when the delay information reporting will be transmitted for the first time to a current moment.

In some embodiments, that the processing unit 1402 performs processing related to de-prioritization of the delay information reporting comprises:
considering that a MAC PDU including the delay information reporting or including a delay information reporting MAC CE has the highest priority; or, the delay information reporting has the highest priority.

In some embodiments, that the processing unit 1402 performs processing related to de-prioritization of the delay information reporting comprises: in a case where a sum of the remaining time included in the delay information reporting and a point-in-time of a next transmission of the delay information reporting exceeds a latency requirement of a service, abandoning transmitting the MAC PDU including the delay information reporting.

In some embodiments, that the processing unit 1402 performs processing related to de-prioritization of the delay information reporting comprises: in a case where the delay information reporting is deprioritized, discarding or canceling the delay information reporting.

In some embodiments, as shown in FIG. 14, the apparatus 1400 further comprises a generating unit which is used by the terminal equipment to regenerate delay information reporting for a next UL-SCH resource or uplink grant, a time reference point of the remaining time included in the regenerated delay information reporting is the next UL-SCH resource.

In some embodiments, that the processing unit 1402 performs processing related to de-prioritization of the delay information reporting comprises: considering that autonomous transmission is not configured, or considering that autonomous transmission is configured and the autonomous transmission is not applied for the delay information reporting.

In some embodiments, that the processing unit 1402 performs processing related to de-prioritization of the delay information reporting comprises: considering that a configured configured grant is not configured with autonomous transmission, or considering that a configured configured grant is configured with autonomous transmission and the terminal equipment does not transmit the delay information reporting in a configured grant configured with autonomous transmission, or does not transmit the delay information reporting in a CG configured with autonomous transmission.

In some embodiments, the transmitting unit 1401 transmits delay information reporting in a dynamically scheduled uplink grant (dynamic grant, DG). The dynamically scheduled uplink grant may be indicated in a PDCCH addressing a C-RNTI of the terminal equipment, for example the terminal equipment may not transmit the delay information reporting in a CG and transmits the delay information reporting only in a DG.

Embodiments of the present disclosure further provide a communication apparatus. The apparatus may, for example, be a network device, or may be one or more parts or components configured in the network device. The apparatus in the embodiments of the present disclosure corresponds to the method in the embodiments of the fourth aspect, the contents same as those in the embodiments of the first and fourth aspect are not repeated.

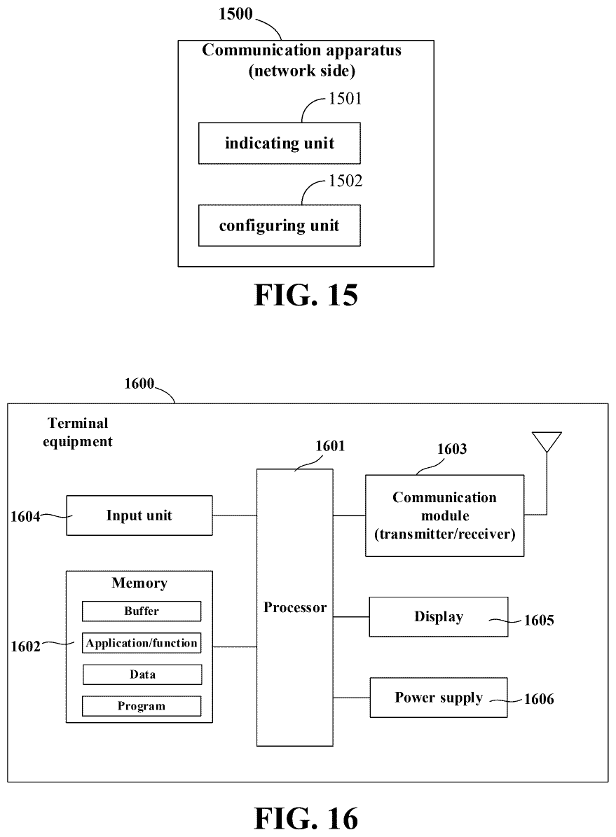

FIG. 15 is a schematic diagram of an example of a communication apparatus in the embodiments of the present disclosure. As shown in FIG. 15, the communication apparatus 1500 in the embodiments of the present disclosure comprises a receiving unit 1501 and/or a configuring unit 1502.

The receiving unit 1501 receives indication information from a terminal equipment, the indication information being used to indicate the network device that the terminal equipment supports calculating or triggering or reporting delay information or remaining time; and the configuring unit 1502 is used to configure to calculate or trigger or report the delay information or the remaining time for at least one radio bearer of the terminal equipment.

In some embodiments, that the terminal equipment indicates to the network device that the terminal equipment supports calculating, triggering or reporting the delay information or the remaining time via the indication information comprises at least one of the following:
the terminal equipment indicates to support calculating or triggering or reporting the delay information or the remaining time;
the terminal equipment indicates to support calculating or triggering or reporting the delay information or the remaining time by indicating a terminal type;
the terminal equipment indicates to support calculating or triggering or reporting the delay information or the remaining time by initiating a specific service; or
the terminal equipment indicates to support calculating or triggering or reporting the delay information or the remaining time by indicating that a PDCP discard timer lower than a first threshold is supported, or by indicating that an extended Discard Timer is supported, or by indicating that a Timer based SDU discard is supported.

In some embodiments, that the configuring unit 1502 configures to calculate or trigger or report the delay information or the remaining time for at least one radio bearer of the terminal equipment comprises at least one of the following:
configuring to calculate or trigger or report the delay information or the remaining time for at least one radio bearer of the terminal equipment; and/or,
configuring an initial value of a PDCP discard timer (PDCP discardTimer) that is not infinity for at least one radio bearer of the terminal equipment; and/or,
configuring an initial value of a PDCP discard timer (discardTimer) lower than a second threshold for at least one radio bearer of the terminal equipment.

The above text is only illustrative for the embodiments of the present disclosure, but the present disclosure is not limited to this, appropriate modifications can be also made based on the above each embodiment. For example, each of the above embodiments may be used individually, or one or more of the above embodiments may be combined.

It's worth noting that the above only describes components or modules related to the present disclosure, but the present disclosure is not limited thereto. Apparatuses 1200 to 1500 in the embodiments of the present disclosure may further comprise other components or modules. For detailed contents of these components or modules, relevant technologies may be referred to. Moreover, the above components or modules may be realized by a hardware facility such as a processor, a memory, a transmitter, a receiver, etc. The embodiments of the present disclosure have no limitation thereto.

According to the apparatus in the embodiments of the present disclosure, it is conducive to meeting latency requirements of the XR service, thereby ensuring QoS of the XR service, and may improve a utilization rate of a wireless resource.

### Embodiments of a Sixth Aspect

Embodiments of the present disclosure further provide a communication system, comprising a network device and a terminal equipment.

In the embodiments of the present disclosure, the terminal equipment comprises the apparatus shown in FIG. 12 in the embodiments of the fifth aspect, configured to perform the method in the embodiments of the first aspect. Since each method has been described in details in the embodiments of the first aspect, its contents are incorporated here and are not repeated.

In the embodiments of the present disclosure, the network device comprises the apparatus shown in FIG. 15 in the embodiments of the fifth aspect, configured to perform the method in the embodiments of the fourth aspect. Since each method has been described in details in the embodiments of the fourth aspect, its contents are incorporated here and are not repeated. In addition, the network device performs normal operations of the network device, and the network device may further perform operations corresponding to the operations of the terminal equipment, for example the network device receives information/signals from the terminal equipment, and/or the network device transmits information/signals to the terminal equipment, descriptions are omitted here.

Embodiments of the present disclosure further provide a terminal equipment, the terminal equipment for example may be a UE, but the present disclosure is not limited to this, it may also be other terminal equipment.

FIG. 16 is a schematic diagram of a terminal equipment in the embodiments of the present disclosure. As shown in FIG. 16, the terminal equipment 1600 may comprise a processor 1601 and a memory 1602; the memory 1602 stores data and programs, and is coupled to the processor 1601. It's worth noting that this figure is exemplary; other types of structures may also be used to supplement or replace this structure, so as to realize a telecommunication function or other functions.

In some embodiments, functions of the apparatus 1200 in the embodiments of the fifth aspect may be integrated into the processor 1601, wherein the processor 1601 may be configured to execute a program to implement the method as described in the embodiments of the first aspect, the contents of which are incorporated herein and are not described repeatedly here.

In some other embodiments, the apparatus 1200 in the embodiments of the fifth aspect may be configured separately from the processor 1601, for example the device in the embodiments of the fifth aspect may be configured as a chip connected to the processor 1601, functions of the apparatus 1200 in the embodiments of the fifth aspect are implemented through the control of the processor 1601.

As shown in FIG. 16, the terminal equipment 1600 may further comprise: a communication module 1603, an input unit 1604, a display 1605 and a power supply 1606. The functions of said components are similar to related arts, which are not repeated here. It's worth noting that the terminal equipment 1600 does not have to include all the components shown in FIG. 16, said components are not indispensable. Moreover, the terminal equipment 1600 may also include components not shown in FIG. 16, relevant technologies can be referred to.

Embodiments of the present disclosure further provide a network device, the network device for example may be a base station, but the present disclosure is not limited to this, it may also be other network device.

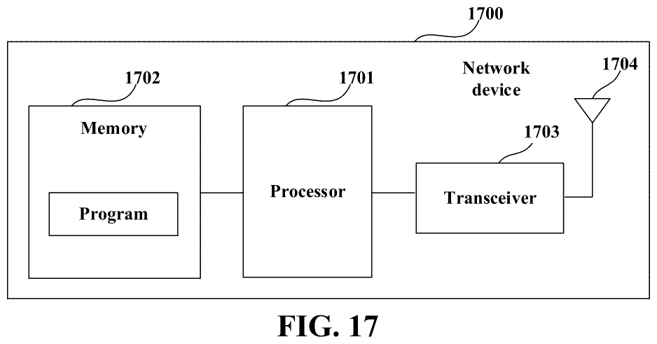

FIG. 17 is a schematic diagram of a network device in the embodiments of the present disclosure. As shown in FIG. 17, the network device 1700 may comprise: a processor 1701 and a memory 1702; the memory 1702 is coupled to the processor 1701. The memory 1702 may store various data; moreover, also stores a program for information processing, and executes the program under the control of the processor 1701.

In some embodiments, functions of the apparatus 1500 in the embodiments of the fifth aspect may be integrated into the processor 1701, wherein the processor 1701 may be configured to execute a program to implement the method as described in the embodiments of the fourth aspect, the contents of which are incorporated herein and are not described repeatedly here.

In some other embodiments, the apparatus 1500 in the embodiments of the fifth aspect may be configured separately from the processor 1701, for example the device in the embodiments of the fifth aspect may be configured as a chip connected to the processor 1701, functions of the apparatus 1500 in the embodiments of the fifth aspect are implemented through the control of the processor 1701.

In addition, as shown in FIG. 17, the network device 1700 may further comprise: transceivers 1703 and 1704. The functions of said components are similar to related arts, which are not repeated here. It's worth noting that the network device 1700 does not have to include all the components shown in FIG. 17. Moreover, the network device 1700 may also include components not shown in FIG. 17, relevant arts can be referred to.

Embodiments of the present disclosure further provide a computer program, wherein when a terminal equipment executes the program, the program enables the terminal equipment to execute the method described in the embodiments of the first aspect.

Embodiments of the present disclosure further provide a storage medium in which a computer program is stored, wherein the computer program enables a terminal equipment to execute the method described in the embodiments of the first aspect.

Embodiments of the present disclosure further provide a computer program, wherein when a network device executes the program, the program enables the network device to execute the method described in the embodiments of the fourth aspect.

Embodiments of the present disclosure further provide a storage medium in which a computer program is stored, wherein the computer program enables a network device to execute the method described in the embodiments of the fourth aspect.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the principle of the present disclosure, these variations and modifications are also within the scope of the present disclosure.

As for the implementations including the above embodiments, the following supplements are further disclosed:
1. An information transmitting method, applicable to a terminal equipment, wherein the method includes:
a PDCP layer or MAC layer of the terminal equipment triggers delay information reporting at; and
the terminal equipment transmits the delay information reporting to a network device via a MAC CE or a PDCP control PDU.
2. The method according to supplement 1, wherein the PDCP layer of the terminal equipment triggers the delay information reporting comprises at least one of the following:
if a value of a discard timer or a value of a first remaining time associated with a PDCP SDU in the PDCP entity is lower than a first threshold, the PDCP entity triggers the delay information reporting;
if a minimum value of a discard timer or of a first remaining time associated with all PDCP SDUs in the PDCP entity is lower than a second threshold, the PDCP entity triggers the delay information reporting;
if a minimum value of a discard timer or of a first remaining time associated with all PDCP SDUs in a PDCP entity associated with a DRB established by the terminal equipment or configured for the terminal equipment is lower than a third threshold, the PDCP layer of the terminal equipment triggers the delay information reporting;
the PDCP layer of the terminal equipment triggers the delay information reporting periodically; or
the PDCP layer of the terminal equipment triggers the delay information reporting when a new PDU set reaches the PDCP layer.
3. The method according to supplement 2, wherein, a period during which the PDCP layer of the terminal equipment triggers the delay information reporting is predefined or is configured by the network device.
4. The method according to supplement 2, wherein that the terminal equipment transmits the delay information reporting via a MAC CE includes:
the PDCP layer of the terminal equipment transfers the value of the discard timer or the value of the first remaining time to the MAC layer;
the MAC layer of the terminal equipment determines a value of a second remaining time according to the value of the discard timer or the value of the first remaining time; and
the MAC layer of the terminal equipment generates a delay information reporting MAC CE and transmits the delay information reporting MAC CE to the network device, the delay information reporting MAC CE containing the value of the second remaining time.
5. The method according to supplement 4, wherein, the value of the second remaining time is a value of remaining time corresponding to a time when the delay information reporting is transmitted for the first time.
6. The method according to supplement 4, wherein that the MAC layer of the terminal equipment determines a value of a second remaining time according to the value of the discard timer or the value of the first remaining time includes:
the MAC layer of the terminal equipment starts a first timer upon receiving the value of the discard timer or the value of the first remaining time transferred by the PDCP layer, the value of the first timer being set to be the value of the discard timer or the value of the first remaining time transferred by the PDCP layer; and
the MAC layer of the terminal equipment determines the value of the second remaining time according to the value of the first timer, the value of the second remaining time being a value of the first timer corresponding to a time when the delay information report is transmitted for the first time.
7. The method according to supplement 4, wherein that the terminal equipment transmits the delay information reporting via a MAC CE further comprises:
the PDCP layer of the terminal equipment indicates to the MAC layer that delay information reporting is triggered, and/or,
the PDCP layer of the terminal equipment indicates the MAC layer to generate a delay information reporting MAC CE.
8. The method according to supplement 4, wherein that the terminal equipment transmits the delay information reporting via a MAC CE further comprises:
the MAC layer of the terminal equipment generates the delay information reporting MAC CE in a case of determining that a UL-SCH resource is available and is capable of accommodating the delay information reporting and a subheader of the delay information reporting.
9. The method according to supplement 2, wherein that the terminal equipment transmits the delay information reporting via a PDCP control PDU comprises:
the MAC layer of the terminal equipment notifies the PDCP layer of a time when a UL-SCH resource that may be used for initial transmission or new transmission of the delay information reporting is located;
the PDCP layer of the terminal equipment determines the value of the second remaining time according to a time when the UL-SCH resource is located;
the PDCP layer of the terminal equipment generates a PDCP control PDU and transmits the delay information reporting to the network device via the PDCP control PDU, the delay information reporting containing the value of the second remaining time.
10. The method according to supplement 9, wherein that the terminal equipment transmits the delay information reporting via a PDCP control PDU further comprises:
the MAC layer of the terminal equipment notifies the PDCP layer of a time when the UL-SCH resource that may be used for initial transmission or new transmission is located in a case of determining that the UL-SCH resource is available and is capable of accommodating the delay information reporting and a subheader of the delay information reporting.
11. The method according to supplement 2, wherein that the terminal equipment transmits the delay information reporting via a PDCP control PDU comprises:
the MAC layer of the terminal equipment determines a value of a second remaining time contained in the delay information reporting;
the MAC layer of the terminal equipment notifies the PDCP layer of the value of the second remaining time;
the PDCP layer of the terminal equipment generates a PDCP control PDU and transmits the delay information reporting to the network device via the PDCP control PDU, the delay information reporting containing the value of the second remaining time.
12. The method according to supplement 11, wherein that the MAC layer of the terminal equipment determines the value of the second remaining time contained in the delay information reporting comprises:
the PDCP layer of the terminal equipment transfers the value of the discard timer or the value of the first remaining time to the MAC layer;
the MAC layer of the terminal equipment starts a second timer upon receiving the value of the discard timer or the value of the first remaining time transferred by the PDCP layer, the value of the second timer being set to be the value of the discard timer or the value of the first remaining time transferred by the PDCP layer; and
the MAC layer of the terminal equipment determines the value of the second remaining time according to the value of the second timer, the value of the second remaining time being a value of the second timer corresponding to a time when the delay information reporting is transmitted for the first time.
13. The method according to supplement 9 or 11, wherein that the terminal equipment transmits the delay information reporting via a PDCP control PDU further comprises:
the PDCP layer of the terminal equipment indicates to the MAC layer that delay information reporting is triggered.
14. The method according to supplement 1, wherein the MAC layer of the terminal equipment triggers the delay information reporting comprises:
the PDCP layer of the terminal equipment transfers a value of at least one discard timer or a value of at least one first remaining time associated with the PDCP SDU in the PDCP entity to the MAC layer; and
the MAC layer of the terminal equipment determines whether to trigger the delay information reporting according to the value of the at least one discard timer or the value of the at least one first remaining time.
15. The method according to supplement 14, wherein,
the MAC layer of the terminal equipment triggers the delay information reporting when the value of the at least one discard timer or the value of the at least one first remaining time is less than an eleventh threshold.
16. The method according to supplement 14, wherein,
the PDCP entity of the terminal equipment obtains a minimum value of the discard timers or of the first remaining times associated with all PDCP SDUs in the PDCP entity, and transmits the minimum value to the MAC layer; and
the MAC layer of the terminal equipment triggers the delay information reporting when a minimum value in minimum values transferred by all PDCP entities is less than a fourth threshold.
17. The method according to supplement 14, wherein,
the PDCP layer of the terminal equipment transfers a minimum value in values of the discard timers or values of the first remaining times associated with all PDCP SDUs to the MAC layer; and
the MAC layer of the terminal equipment triggers the delay information reporting when the minimum value is less than a fifth threshold.
18. The method according to supplement 14, wherein,
the PDCP entity or the PDCP layer of the terminal equipment transfers the value of more than one discard timer or the value of more than one first remaining time to the MAC layer; and
the MAC layer of the terminal equipment triggers the delay information reporting when a minimum value in the value of the more than one discard timer or the value of the more than one first remaining time is less than a sixth threshold.
19. The method according to supplement 1, wherein that the MAC layer of the terminal equipment triggers the delay information reporting comprises:
the MAC layer of the terminal equipment obtains a value of at least one discard timer or a value of at least one first remaining time; and
the MAC layer of the terminal equipment determines whether to trigger the delay information reporting according to the value of the at least one discard timer or the value of the at least one first remaining time.
20. The method according to supplement 19, wherein,
the MAC layer of the terminal equipment triggers the delay information reporting when a minimum value in the value of the at least one discard timer or the value of the at least one first remaining time is less than a seventh threshold.
21. The method according to supplement 19, wherein
the MAC layer of the terminal equipment triggers the delay information reporting when the value of the at least one discard timer or the value of the at least one first remaining time is less than a seventh threshold.
22. The method according to any one of supplements 14-21, wherein that the MAC layer of the terminal equipment determines whether to trigger the delay information reporting according to the value of the at least one discard timer or the value of the at least one first remaining time comprises:
the MAC layer of the terminal equipment starts a third timer upon receiving the value of the discard timer or the value of the first remaining time transferred by the PDCP layer, the value of the third timer being set to be the value of the discard timer or the value of the first remaining time transferred by the PDCP layer; and
triggers the delay information reporting when the value of the third timer is lower than an eighth threshold.
23. The method according to any one of supplements 14-21, wherein that the terminal equipment transmits the delay information reporting via a MAC CE comprises:
the MAC layer of the terminal equipment determines a value of a second remaining time according to the value of the at least one discard timer or the value of the at least one first remaining time; and
the MAC layer of the terminal equipment generates a delay information reporting MAC CE and transmits the delay information reporting MAC CE to the network device, the delay information reporting MAC CE containing the value of the second remaining time.
24. The method according to supplement 23, wherein
the value of the second remaining time is a value of remaining time corresponding to a time when the delay information reporting is transmitted for the first time; or,
the value of the second remaining time is a value of a third timer corresponding to a time when the delay information reporting is transmitted for the first time, the third timer being a timer started by the MAC layer of the terminal equipment when receiving the value of the at least one discard timer or the value of the at least one first remaining time transferred by the PDCP layer.
25. The method according to supplement 23, wherein that the terminal equipment transmits the delay information reporting via a MAC CE further includes:
the MAC layer of the terminal equipment requests the PDCP layer to transfer the value of the at least one discard timer or the value of the at least first remaining time.
26. The method according to supplement 23, wherein that the terminal equipment transmits the delay information reporting via a MAC CE further comprises:
the MAC layer of the terminal equipment generates the delay information reporting MAC CE in a case of determining that a UL-SCH resource is available and is capable of accommodating the delay information reporting and a subheader of the delay information reporting.
27. The method according to any one of supplements 14-21, wherein that the terminal equipment transmits the delay information reporting via a PDCP control PDU comprises:
the MAC layer of the terminal equipment determines a value of a second remaining time contained in the delay information reporting;
the MAC layer of the terminal equipment notifies the PDCP layer of the value of the second remaining time;
the PDCP layer of the terminal equipment generates a PDCP control PDU and transmits the delay information reporting to the network device via the PDCP control PDU, the delay information reporting containing the value of the second remaining time.
28. The method according to supplement 27, wherein that the terminal equipment transmits the delay information reporting via a PDCP control PDU further comprises:
the MAC layer of the terminal equipment requests the PDCP layer to transfer the value of the at least one discard timer or the value of the at least first remaining time.
29. The method according to supplement 27, wherein
the value of the second remaining time is a value of a third timer corresponding to a time when the delay information reporting is transmitted for the first time, the third timer being a timer started by the MAC layer of the terminal equipment when receiving the value of the at least one discard timer or the value of the at least one first remaining time transferred by the PDCP layer.
30. The method according to supplement 27, wherein that the terminal equipment transmits the delay information reporting via a PDCP control PDU further comprises:
the MAC layer of the terminal equipment notifies the PDCP layer of a time when the UL-SCH resource that may be used for initial transmission or new transmission is located in a case of determining that the UL-SCH resource is available and is capable of accommodating the delay information reporting and a subheader of the delay information reporting.
31. The method according to any one of supplements 1-30, wherein the method further includes:
the terminal equipment starts or restarts a fourth timer when triggering or transmitting delay information reporting; and/or,
the terminal equipment does not trigger or does not transmit the delay information reporting during running of the fourth timer; and/or,
the terminal equipment considers that the fourth timer expires when the delay information reporting is cancelled.
32. The method according to supplement 31, wherein,
a value of the fourth timer is predefined, or is configured by the network device.
33. The method according to any one of supplements 1-32, wherein the method further includes:
the terminal equipment indicates to the network device that the terminal equipment supports calculating, triggering or reporting delay information or remaining time; and/or,
at least one radio bearer of the terminal equipment is configured by the network device to calculate or trigger or report the delay information or the remaining time.
34. The method according to supplement 33, wherein that the terminal equipment indicates to the network device that the terminal equipment supports calculating, triggering or reporting the delay information or the remaining time comprises at least one of the following:
the terminal equipment indicates to support calculating or triggering or reporting the delay information or the remaining time;
the terminal equipment indicates to support calculating or triggering or reporting the delay information or the remaining time by indicating a terminal type;
the terminal equipment indicates to support calculating or triggering or reporting the delay information or the remaining time by initiating a specific service; or
the terminal equipment indicates to support calculating or triggering or reporting the delay information or the remaining time by indicating that a PDCP discard timer lower than a ninth threshold is supported, or by indicating that an extended Discard Timer is supported, or by indicating that a Timer based SDU discard is supported.
35. The method according to supplement 33, wherein that at least one radio bearer of the terminal equipment is configured by the network device to calculate or trigger or report the delay information or the remaining time comprises at least one of the following:
at least one radio bearer of the terminal equipment is configured by the network device to calculate or trigger or report the delay information or the remaining time;
at least one radio bearer of the terminal equipment is configured by the network device with an initial value of a PDCP discard timer (discardTimer) that is not infinity; or
at least one radio bearer of the terminal equipment is configured by the network device with an initial value of a PDCP discard timer (discardTimer) lower than a tenth threshold.
36. The method according to any one of supplements 1-35, wherein the method further includes:
transmitting indication information to the network device, the indication information including at least one of the following:
a point-in-time when the delay information reporting will be transmitted for the first time;
the delay information reporting is deprioritized in previous physical resource;
the delay information reporting is retransmitted; or
a time difference from a point-in-time when the delay information reporting will be transmitted for the first time to a current moment.
37. The method according to any one of supplements 1-35, wherein,
a MAC PDU including the delay information reporting or including a delay information reporting MAC CE has the highest priority; or,
the delay information reporting has the highest priority.
38. The method according to any one of supplements 1-35, wherein,
if a sum of the remaining time included in the delay information reporting and a point-in-time of a next transmission of the delay information reporting exceeds a latency requirement of a service, the terminal equipment abandons transmitting the MAC PDU including the delay information reporting.
39. The method according to any one of supplements 1-35, wherein,
if the delay information reporting is deprioritized, the terminal equipment discards or cancels the delay information reporting.
40. The method according to supplement 39, wherein the method further includes:
the terminal equipment regenerates delay information reporting for a next UL-SCH resource or uplink grant, a time reference point of the remaining time included in the regenerated delay information reporting is the next UL-SCH resource.
41. The method according to any one of supplements 1-35, wherein,
the terminal equipment is not configured with autonomous transmission (or autonomousTx), the terminal equipment being a terminal equipment that performs delay information calculation or triggering or reporting, or
the terminal equipment is configured with autonomous transmission (or autonomousTx), the terminal equipment does not apply autonomous transmission to the delay information reporting.
42. The method according to any one of supplements 1-35, wherein,
a configured grant configured for the terminal equipment is not configured with autonomous transmission (or autonomousTx), the terminal equipment being a terminal equipment that performs delay information calculation or triggering or reporting, or
a configured grant configured for the terminal equipment is configured with autonomous transmission (or autonomousTx), the terminal equipment does not transmit the delay information reporting in a configured grant configured with autonomous transmission, or
the terminal equipment does not transmit the delay information reporting in a configured grant configured with autonomous transmission.
43. A communication method, applicable to a terminal equipment, wherein the method includes:
the terminal equipment indicates to the network device that the terminal equipment supports calculating, triggering or reporting delay information or remaining time.
44. The method according to supplement 43, wherein that the terminal equipment indicates to the network device that the terminal equipment supports calculating, triggering or reporting the delay information or the remaining time comprises at least one of the following:
the terminal equipment indicates to support calculating or triggering or reporting the delay information or the remaining time;
the terminal equipment indicates to support calculating or triggering or reporting the delay information or the remaining time by indicating a terminal type;
the terminal equipment indicates to support calculating or triggering or reporting the delay information or the remaining time by initiating a specific service; or
the terminal equipment indicates to support calculating or triggering or reporting the delay information or the remaining time by indicating that a PDCP discard timer lower than a first threshold is supported, or by indicating that an extended Discard Timer is supported, or by indicating that a Timer based SDU discard is supported.
45. A communication method, applicable to a terminal equipment, wherein the method includes:
at least one radio bearer of the terminal equipment is configured by the network device to calculate or trigger or report the delay information or the remaining time.
46. The method according to supplement 45, wherein that at least one radio bearer of the terminal equipment is configured by the network device to calculate or trigger or report the delay information or the remaining time comprises at least one of the following:
at least one radio bearer of the terminal equipment is configured by the network device to calculate or trigger or report the delay information or the remaining time;
at least one radio bearer of the terminal equipment is configured by the network device with an initial value of a PDCP discard timer (discardTimer) that is not infinity; or
at least one radio bearer of the terminal equipment is configured by the network device with an initial value of a PDCP discard timer (discardTimer) lower than a second threshold.
47. An information transmitting method, applicable to a terminal equipment, wherein the method includes:
the terminal equipment transmits delay information reporting to a network device; and
the terminal equipment performs processing related to de-prioritization of the delay information reporting.
48. The method according to supplement 47, wherein that the terminal equipment performs processing related to de-prioritization of the delay information reporting comprises:
the terminal equipment transmits first indication information to the network device, the first indication information including at least one of the following:
a point-in-time when the delay information reporting will be transmitted for the first time;
the delay information reporting is deprioritized in previous physical resource;
the delay information reporting is retransmitted; or
a time difference from a point-in-time when the delay information reporting will be transmitted for the first time to a current moment.
49. The method according to supplement 47, wherein that the terminal equipment performs processing related to de-prioritization of the delay information reporting comprises:
the terminal equipment considers that a MAC PDU including the delay information reporting or including a delay information reporting MAC CE has the highest priority; or, the delay information reporting has the highest priority.
50. The method according to supplement 47, wherein that the terminal equipment performs processing related to de-prioritization of the delay information reporting comprises:
in a case where a sum of the remaining time included in the delay information reporting and a point-in-time of a next transmission of the delay information reporting exceeds a latency requirement of a service, the terminal equipment abandons transmitting the MAC PDU including the delay information reporting.
51. The method according to supplement 47, wherein that the terminal equipment performs processing related to de-prioritization of the delay information reporting comprises:
in a case where the delay information reporting is deprioritized, the terminal equipment discards or cancels the delay information reporting.
52. The method according to supplement 51, wherein the method further includes:
the terminal equipment regenerates delay information reporting for a next UL-SCH resource or uplink grant, a time reference point of the remaining time included in the regenerated delay information reporting is the next UL-SCH resource.
53. The method according to supplement 47, wherein that the terminal equipment performs processing related to de-prioritization of the delay information reporting comprises:
the terminal equipment considers not to be configured with autonomous transmission, or,
the terminal equipment considers to be configured with autonomous transmission, and the terminal equipment does not apply autonomous transmission to the delay information reporting.
54. The method according to supplement 47, wherein that the terminal equipment performs processing related to de-prioritization of the delay information reporting comprises:
the terminal equipment considers that a configured configured grant is not configured with autonomous transmission, or
the terminal equipment does not transmit the delay information reporting in a configured grant configured with autonomous transmission.
55. A communication method, applicable to a network device, wherein the method includes:
the network device is indicated by a terminal equipment that the terminal equipment supports calculating, triggering or reporting delay information or remaining time.
56. The method according to supplement 55, wherein that the network device is indicated by a terminal equipment that the terminal equipment supports calculating, triggering or reporting delay information or remaining time comprises at least one of the following:
the terminal equipment indicates to support calculating or triggering or reporting the delay information or the remaining time;
the terminal equipment indicates to support calculating or triggering or reporting the delay information or the remaining time by indicating a terminal type;
the terminal equipment indicates to support calculating or triggering or reporting the delay information or the remaining time by initiating a specific service; or
the terminal equipment indicates to support calculating or triggering or reporting the delay information or the remaining time by indicating that a PDCP discard timer lower than a first threshold is supported, or by indicating that an extended Discard Timer is supported, or by indicating that a Timer based SDU discard is supported.
57. A communication method, applicable to a network device, wherein the method includes:
the network device configures for at least one radio bearer of the terminal equipment to calculate or trigger or report the delay information or the remaining time.
58. The method according to supplement 57, wherein that the network device configures for at least one radio bearer of the terminal equipment to calculate or trigger or report the delay information or the remaining time comprises at least one of the following:
the network device configures for at least one radio bearer of the terminal equipment to calculate or trigger or report the delay information or the remaining time;
the network device configures an initial value of a PDCP discard timer (PDCP discardTimer) that is not infinity, for at least one radio bearer of the terminal equipment; or
the network device configures an initial value of a PDCP discard timer (discardTimer) lower than a second threshold, for at least one radio bearer of the terminal equipment.
59. A terminal equipment, comprising a memory and a processor, the memory storing a computer program, and the processor being configured to execute the computer program to implement the method according to any one of supplements 1-54.
60. A network device, comprising a memory and a processor, the memory storing a computer program, and the processor being configured to execute the computer program to implement the method according to any one of supplements 55-58.
61. A communication system, comprising the network device according to supplement 60 and the terminal equipment according to supplement 59.

What is claimed is:

1. An information transmitting apparatus, configured in a terminal equipment, the apparatus comprising:
processor circuitry configured to trigger a delay information reporting at a media access control layer of the terminal equipment; and
a transmitter configured to transmit the delay information reporting to a network device via a media access control control element,
wherein that the processor circuitry triggers the delay information report at the media access control layer of the terminal equipment comprises:
the media access control layer of the terminal equipment determines whether to trigger the delay information report according to a value of at least one discard timer.

2. The apparatus according to claim 1, wherein that the transmitter transmits the delay information reporting via the media access control control element further comprises:
the media access control layer of the terminal equipment generates the delay information reporting media access control control element in a case of determining that an uplink shared channel resource is available and is able to accommodate the delay information reporting and a subheader of the delay information reporting.

3. The apparatus according to claim 1, wherein,
the media access control layer of the terminal equipment triggers the delay information reporting when the value of the at least one discard timer is less than an eleventh threshold.

4. The apparatus according to claim 1, wherein,
the media access control layer of the terminal equipment triggers the delay information reporting when a minimum value in the value of the at least one discard timer is less than a seventh threshold.

5. The apparatus according to claim 1, wherein,
the media access control layer of the terminal equipment triggers the delay information reporting when a value of the at least one discard timer is less than a seventh threshold.

6. The apparatus according to claim 1, wherein that the transmitter transmits the delay information reporting via the media access control control element comprises:
the media access control layer of the terminal equipment determines a value of a second remaining time according to the value of the at least one discard timer; and
the media access control layer of the terminal equipment generates a delay information reporting media access control control element and transmits the delay information reporting media access control control element to the network device, the delay information reporting media access control control element containing the value of the second remaining time.

7. The apparatus according to claim 1, wherein
the processor circuitry is configured to start or restart a fourth timer when the delay information reporting is triggered or when the a delay information reporting is transmitted,
wherein the delay information reporting is not triggered or transmitted when the fourth timer is running, and/or, the fourth timer is considered as expired when the delay information reporting is canceled.

8. The apparatus according to claim 7, wherein,
a value of the fourth timer is predefined, or is configured by the network device.

9. A communication system, comprising a terminal equipment and a network device, wherein the terminal equipment is configured to execute the following method:
triggering a delay information reporting at a media access control layer; and
transmitting the delay information reporting to the network device via a media access control control element.

10. An information transmission apparatus, configured in a terminal equipment, the apparatus comprising:
a transmitter configured to transmit indication information to a network device to indicate that the terminal equipment supports reporting delay information.

11. The apparatus according to claim 10, wherein the indication information is included in UE Capability Information message.

12. The apparatus according to claim 10, wherein a presence of the indication information indicates that the terminal equipment supports reporting delay information.

13. The apparatus according to claim 10, wherein the indication information is one bit.
